(19) United States
(12) Patent Application Publication
(10) Pub. No.: US 2012/0029956 A1
(43) Pub. Date: Feb. 2, 2012

(54) COMPREHENSIVE EXPOSURE ANALYSIS SYSTEM AND METHOD

(75) Inventors: Debashis Ghosh, Charlotte, NC (US); Sudeshna Banerjee, Waxhaw, NC (US); David Joa, Irvine, CA (US); Hemant Kagade, Charlotte, NC (US); Ivan Allen Marcotte, Charlotte, NC (US); Randall John Miller, Charlotte, NC (US); John Arthur Scowcroft, Salt Lake City, UT (US)

(73) Assignee: BANK OF AMERICA CORPORATION, Charlotte, NC (US)

(21) Appl. No.: 12/847,394

(22) Filed: Jul. 30, 2010

(51) Int. Cl. G06Q 10/00; G06Q 40/00

(52) U.S. Cl. 705/7.11; 705/35

(57) ABSTRACT

Embodiments of the invention allow an institution to obtain a more comprehensive view of its exposure to one or more entities or groups of entities and, in some cases, to use this information to identify opportunities for and/or risks to the institution. For example, embodiments of the invention involve systems and methods for: (1) selecting an entity; (2) determining exposure to the entity in isolation; (3) determining one or more related entities based on transaction data associated with the selected entity; (4) determining exposure to the one or more related entities; and (5) combining the exposure data for the selected entity and the related entities to obtain comprehensive exposure metrics for the selected entity. Some embodiments of the invention further involve aggregating the comprehensive entity exposure metrics for several entities based on entity characteristics to create other exposure metrics, and then displaying exposure metrics to a user on a display based on user-selected entities or entity characteristics.

### FIELD

Embodiments of the invention relate to apparatuses and methods for determining the exposure of an organization to one or more entities or groups of entities.

### BACKGROUND

Businesses are always looking for new opportunities and evaluating the risk associated with both existing opportunities and possible new opportunities. As such, businesses are often interested to know where they are overexposed and underexposed to particular current customers, groups of current customers, potential customers, and groups of potential customers. For example, many financial institutions lend money to customers in the form of loans and lines of credit. It is important for these financial institutions to have an accurate view of their exposure to risk associated with these loans and lines of credit. With an accurate picture of the financial institution's exposure to risk, new opportunities may become apparent in areas where the financial institution is underexposed to risk. In areas where the financial institution determines that it is overexposed to risk, the financial institution can take appropriate actions to reduce or hedge the risk in those areas.

Unfortunately, however, it can be difficult for many businesses, especially large businesses, to accurately determine and easily assess the business's current or potential exposure to a customer or group of customers due to the complexity of the economy and interrelationships between customers. Current techniques and systems used to determine a business's exposure to customers or groups of customers are generally primitive and fail to give a full and accurate picture of the complexities of a business's exposure profile.

### BRIEF SUMMARY

Embodiments of the present invention address the above needs and/or achieve other advantages by providing apparatuses (e.g., systems, computer program products, machines, and/or other devices) and methods that provide for a more comprehensive exposure analysis and that further provide mechanisms for more easily viewing the results of the comprehensive exposure analysis. More specifically, embodiments of the invention allow an institution to obtain a more comprehensive view of its exposure to one or more entities or groups of entities and, in some cases, to use this information to identify opportunities for and/or risks to the institution. For example, embodiments of the invention involve systems and methods for: (1) selecting an entity; (2) determining exposure to the entity in isolation; (3) determining one or more related entities based on transaction data associated with the selected entity; (4) determining exposure to the one or more related entities; and (5) combining the exposure data for the selected entity and the related entities to obtain comprehensive exposure metrics for the selected entity. Some embodiments of the invention further involve aggregating the comprehensive entity exposure metrics for several entities based on entity characteristics to create other exposure metrics, and then displaying exposure metrics to a user on a display based on user-selected entities or entity characteristics.

For example, embodiments of the invention provide an apparatus including a memory having account information stored therein about a plurality of accounts. The account information includes transaction information and exposure information for each of the plurality of accounts. The apparatus also includes a processor communicably coupled to the memory and configured to: (1) identify a selected entity; (2) use the transaction information to identify one or more related entities that are related to the selected entity, (3) use the account information to identify exposure information for the one or more related entities, and (4) determine a comprehensive view of the exposure to the selected entity based at least in part on the exposure information of the one or more related entities. Some embodiments of the apparatus further include a communication interface communicably coupled to the processor and a display device, wherein the processor is further configured to use the communication interface to present on the display device the comprehensive view of the exposure to the selected entity.

In some embodiments of the apparatus, the processor is configured to use the account information to identify information about direct exposure to the selected entity in isolation, and further configured to determine the comprehensive view of the exposure to the selected entity based at least in part on a combination of the exposure information of the one or more related entities and the information about direct exposure to the selected entity. In some such embodiments, the processor is configured to determine the comprehensive view of the exposure to the selected entity by adding together the exposure information of the one or more related entities and the information about direct exposure to the selected entity. In some such embodiments, the processor is configured to apply weighting factors to the exposure information of the one or more related entities, and further configured to determine the comprehensive view of the exposure to the selected entity based at least in part on the weighting factors, the exposure information of the one or more related entities, and the information about direct exposure to the selected entity. For example, the processor may be configured to use the transaction information to identify a type of relationship between the one or more related entities and the selected entity, and further configured to apply the weighting factors to the exposure information of the one or more related entities based at least in part on the type of relationship.

In some embodiments of the apparatus, the processor is further configured to: determine comprehensive exposure information for each of a plurality of selected entities; and aggregate the comprehensive views for a subset of the plurality of selected entities based on a common characteristic shared by the subset of the plurality of selected entities. In some such embodiments, the apparatus includes a user interface configured to receive a user-selected characteristic from a user, and the processor is configured to, in response to receiving the user-selected characteristic from the user, present the user with information about an aggregate of the comprehensive views for a subset of the plurality of selected entities, where the subset of the plurality of selected entities share the user-selected characteristic. The common characteristic may include, for example, a sector of the economy, an industry, or a geographic indicator.

In some embodiments of the apparatus, the account information includes information about accounts that customers have with an institution, the transaction information includes information about transactions processed at least in part by the institution for the customers, the exposure information for the one or more related entities includes the institution's exposure to the one or more related entities, and the comprehensive view of the exposure to the selected entity includes an estimate of the institution's exposure to the selected entity based at least in part on the one or more related entities. For example, the institution may be a bank, the accounts may be bank accounts, and the transactions may be financial transactions.

In some embodiments of the apparatus, the selected entity is a company and the one or more related entities are employees of the company. In some embodiments, selected entity is a company and the one or more related entities are suppliers, distributors, contractors, or affiliates of the company. In other embodiments, the selected entity is an individual and the one or more related entities include an employer of the individual.

In some embodiments of the apparatus, the transaction information includes information about direct deposit, Automated Clearing House (ACH), check, payment, or payroll transactions, and the processor is configured to identify the one or more related entities as being related to the selected entity based on the selected party engaging in a pre-defined frequency of direct deposit, ACH, check, payment, or payroll transactions with the one or more related entities.

In some embodiments of the apparatus, the processor is configured to identify the one or more related entities as being related to the selected entity based on the selected party engaging in a pre-defined frequency of transactions with the one or more related entities.

In some embodiments, the exposure information for the one or more related entities includes an institution's credit exposure to the one or more related entities, and the comprehensive view of the exposure to the selected entity includes an estimate of the institution's credit exposure to the selected entity based at least in part on the one or more related entities. In some such embodiments, the credit exposure includes loan or line of credit balances. In other embodiments of the apparatus, the exposure information for the one or more related entities includes an institution's revenue exposure to the one or more related entities, and the comprehensive view of the exposure to the selected entity includes an estimate of the institution's revenue exposure to the selected entity based at least in part on the one or more related entities.

Embodiments of the invention also provide a method involving: (1) accessing a memory comprising account information stored therein about a plurality of accounts, the account information comprising transaction information and exposure information for each of the plurality of accounts; (2) identifying a selected entity; (3) using a computer to automatically identify, from the transaction information, one or more related entities that are related to the selected entity; (4) using a computer to automatically gather, from the account information, exposure information for the one or more related entities; and (5) using a computer to determine a comprehensive view of the exposure to the selected entity based at least in part on the exposure information of the one or more related entities. The method may further involve: using the account information to identify information about direct exposure to the selected entity in isolation; and using a computer to determine the comprehensive view of the exposure to the selected entity based at least in part on a combination of the exposure information of the one or more related entities and the information about direct exposure to the selected entity.

In some embodiments, the method further includes: using the transaction information to identify a type of relationship between the one or more related entities and the selected entity; applying weighting factors to the exposure information of the one or more related entities based at least in part on the type of relationship; and determining the comprehensive view of the exposure to the selected entity based at least in part on the weighting factors, the exposure information of the one or more related entities, and the information about direct exposure to the selected entity. In some embodiments, the method includes: determining comprehensive exposure information for each of a plurality of selected entities; and aggregating the comprehensive views for a subset of the plurality of selected entities based on a common characteristic shared by the subset of the plurality of selected entities.

In some embodiments of the method, the transaction information includes information about direct deposit, Automated Clearing House (ACH), check, payment, or payroll transactions, and the method further involves: identifying the one or more related entities as being related to the selected entity based on the selected party engaging in a pre-defined frequency of direct deposit, Automated Clearing House (ACH), check, payment, or payroll transactions with the one or more related entities.

In some embodiments, the method involves identifying the one or more related entities as being related to the selected entity based on the selected party engaging in a pre-defined frequency of transactions with the one or more related entities.

Embodiments of the invention also provide a computer program product comprising a non-transitory computer readable medium having computer-executable program code stored therein, wherein the computer-executable program code comprises: (1) a first code portion configured to access a memory comprising account information stored therein about a plurality of accounts, the account information comprising transaction information and exposure information for each of the plurality of accounts; (2) a second code portion configured to identify a selected entity; (3) a third code portion configured to identify, from the transaction information, one or more related entities that are related to the selected entity; (4) a fourth code portion configured to gather, from the account information, exposure information for the one or more related entities; and (5) a fifth code portion configured to determine a comprehensive view of the exposure to the selected entity based at least in part on the exposure information of the one or more related entities.

The features, functions, and advantages that have been discussed may be achieved independently in various embodiments of the present invention or may be combined in yet other embodiments, further details of which can be seen with reference to the following description and drawings.

### BRIEF DESCRIPTION OF THE SEVERAL VIEWS OF THE DRAWINGS

Having thus described embodiments of the invention in general terms, reference will now be made to the accompanying drawings, wherein:

FIG. 1 provides a block diagram illustrating a comprehensive exposure analysis system in accordance with an embodiment of the present invention;

FIG. 2 provides a flow diagram illustrating a method of performing a comprehensive exposure analysis in accordance with an embodiment of the present invention;

FIG. 3 provides a flow diagram illustrating an example embodiment of the method of FIG. 2 in which a bank uses its transaction data associated with a particular company along with exposure metrics of the company and other bank customers to perform a comprehensive exposure analysis for the company;

FIG. 4 provides a flow diagram illustrating a particular method of performing a comprehensive exposure analysis for a company in accordance with an example embodiment of the invention;

FIG. 5 provides a flow diagram illustrating a particular method of performing a comprehensive exposure analysis for an individual in accordance with an example embodiment of the invention;

FIG. 6A provides an exposure analysis interface illustrating an example chart and graph of an institution's total exposure by sector of the economy, in accordance with an embodiment of the present invention;

FIG. 6B provides an exposure analysis interface illustrating an example chart and graph of an institution's total exposure by industry to a particular user-selected sector of the economy, in accordance with an embodiment of the present invention;

FIG. 6C provides an exposure analysis interface illustrating an example chart and graph of an institution's total exposure by company to a particular user-selected industry, in accordance with one embodiment of the present invention;

FIG. 7A provides an exposure analysis interface illustrating example interface controls and an example diagram of an institution's total exposure for a particular user-selected attribute based on sector, industry, and company, in accordance with one embodiment of the present invention;

FIG. 7B provides an exposure analysis interface illustrating a geographic chart of an institution's customers that are associated with (e.g., employees and/or other business partners of) a particular user-selected company, in accordance with one embodiment of the present invention;

FIG. 7C provides an exposure analysis interface illustrating a chart and graph of an institution's exposures to employees of a particular user-selected company, in accordance with one embodiment of the present invention;

FIG. 8 provides a block diagram illustrating a combined commercial and consumer credit system and environment, in accordance with an embodiment of the present invention; and

FIG. 9 provides a flow diagram illustrating a combined commercial and consumer credit exposure analysis process, in accordance with one embodiment of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Although some embodiments of the invention described herein are described as involving a “bank” or “financial institution,” one of ordinary skill in the art will appreciate that other embodiments of the invention may involve other institutions that take the place of or work in conjunction with the bank or other financial institution to perform the described function or maintain the described system. Like numbers refer to like elements throughout.

As described briefly above, embodiments of the invention relate generally to apparatuses and methods for providing a more comprehensive exposure analysis for an institution. For example, some embodiments of the invention are configured to analyze the risk exposure that a bank has to a particular company by virtue of its loan and line of credit products. When conducting this exposure analysis for the bank, embodiments of the invention look not only at the loans and lines of credit extended by the bank to the particular company, but also at the loans and lines of credit extended to employees, suppliers, contractors, and/or other business partners of the company to get a more comprehensive view of the bank's exposure to the company. This type of comprehensive view of the bank's credit exposure may be more accurate because if the particular company fails, then the company's employees, suppliers, contractors, and/or other business partners may also experience financial hardship that would put the credit extended by the bank to these parties also at risk. As such, an accurate analysis of the bank's credit exposure to a particular company should take into account not only the credit extended to the company, but also at least some portion of the credit extended to parties that rely on this particular company. Some embodiments of the invention perform this analysis by, amongst other things, using information that the bank has about financial transactions between the company and its business partners to automatically identify those entities that should be taken into account in the exposure analysis of the company. For example, some embodiments of the invention provide a computer system configured to analyze a bank's direct deposit information for its customers to identify which customers are employees of the particular company in question and then automatically consider the bank's exposure to these customers during the exposure analysis of the company. Some embodiments of the invention are also configured to aggregate the exposure analysis for all of the companies in a particular sector of the economy, industry, or geographical area in order to more accurately view the bank's exposure to the particular sector of the economy, industry, or geographical area. This paragraph briefly describes just one example of how embodiments of the invention may be configured to help a bank to more accurately assess its risk. In another example, embodiments of the invention identify risks and/or business opportunities for an institution by analyzing an institution's revenue exposure to a sector of the economy, industry, geographic area, company, individual, group of individuals, or other entity or group of entities by, for example, using transaction data to associate the sector of the economy, industry, geographic area, company, individual, group of individuals, or other entity or group of entities with other sectors of the economy, industries, geographic areas, companies, individuals, groups of individuals, and/or other entities or groups of entities and combining their revenue numbers to provide a more accurate picture of the institution's revenue exposure. These examples and numerous other examples of embodiments of the invention are described in greater detail below.

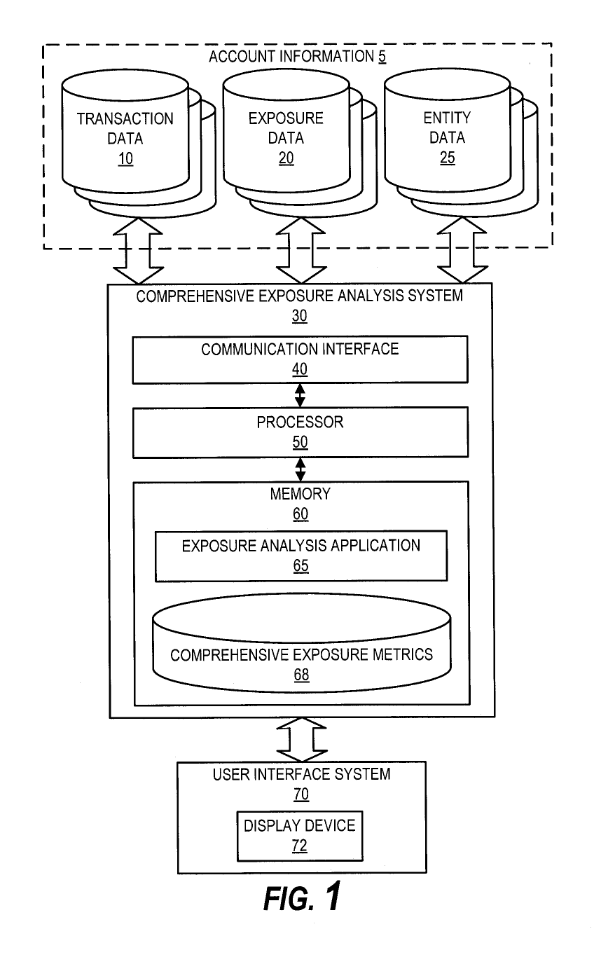

FIG. 1 provides a block diagram of a comprehensive exposure analysis system 30, in accordance with an embodiment of the invention. As illustrated, the comprehensive exposure analysis system 30 includes a communication interface 40, a memory 60, and a processor 50 communicably coupled to the communication interface 40 and the memory 60. As used herein, when it is said that two devices are “communicably coupled” or “operatively coupled” it means the two devices are coupled by one or more wired or wireless connections or networks such that one or more communications can be sent between the devices and/or so that one device can use the other device to perform one or more operations.

The communication interface 40 is generally configured to allow the comprehensive exposure analysis system 30 or components thereof to communicate with other systems, devices, components, and/or users. In this regard, as used herein, a “communication interface” generally includes hardware, and, in some instances, software, that enables a portion of the system in which it resides, such as the comprehensive exposure analysis system 30, to transport, send, receive, and/or otherwise communicate information to and/or from a user and/or the communication interface of one or more other systems or system devices. For example, the communication interface 40 of the comprehensive exposure analysis system 30 may include a network interface and a user interface. The communication interface 40, and any network interface or user interface, may be made up of a single device or multiple devices that may or may not be coupled together. In other words, although a communication interface 40 is illustrated in FIG. 1 as one block in the block diagram, the communication interface 40 may comprise one or more separate systems/devices that perform the functions of the communication interface 40 described herein.

As used herein, a “network interface” generally includes hardware, and, in some instances, software, that enables a system or a portion of a system to transport, send, receive, and/or otherwise communicate information to and/or from the network interface of one or more other systems or portions of the system via a network. As used herein, a “network” is any system for communicating information from one device/system to another device/system and may include, for example, a global area network, wide area network, local area network, wireless network, wire-line network, secure encrypted network, virtual private network, one or more direct electrical connections, and/or the like. As such, a network interface may include a wired or wireless modem, server, electrical connection, and/or other electronic device that communicably connects one device/system to another device/system on the network and, in some cases, is configured to communicate using one or more particular network communication protocols.

As used herein, a “user interface” generally includes one or more user output devices, such as a display and/or speaker, for presenting information to a user. In some embodiments, the user interface further includes one or more user input devices, such as one or more buttons, keys, dials, levers, directional pads, joysticks, accelerometers, controllers, microphones, touchpads, touchscreens, haptic interfaces, scanners, motion detectors, cameras, and/or the like for receiving information from a user.

In the illustrated embodiment, the communication interface 40 is configured to communicate input from and/or output to a user interface system 70. The user interface system 70 may be part of the comprehensive exposure analysis system 30 and, as such, maintained by the same entity that maintains the comprehensive exposure analysis system 30. Alternatively, the user interface system 70 may be maintained by an entity other than the entity that maintains the comprehensive exposure analysis system 30 and may be, for example, a personal computer, mobile phone, or other personal user interface device. In either case, the user interface system 70 may be communicably coupled to the communication interface 40 via a network, and the user interface system 70 may be either co-located with or located remote from the other devices of the comprehensive exposure analysis system 30.

As also illustrated in FIG. 1, the comprehensive exposure analysis system 30 is configured to communicate with a transaction data datastore 10, an exposure data datastore 20, and an entity data datastore 25. In some embodiments of the invention, the transaction data datastore 10, the exposure data datastore 20, and/or the entity data datastore 25 are stored on the memory devices of one or more other systems, such as one or more banking computer systems, which may or may not be maintained by the same entity maintaining the comprehensive exposure analysis system 30. In other embodiments, the transaction data 10, exposure data 20, and/or entity data 25 are stored in memory 60 of the comprehensive exposure analysis system 30. In embodiments where the transaction data 10, the exposure data 20, and/or entity data 25 are located in other systems, the comprehensive exposure analysis system 30 may be configured to communicate with those systems via a network interface of the communication interface 40 and a network that, in some embodiments, uses one or more encryption techniques and/or secure communication protocols to ensure the confidentiality of the information communicated. In one embodiment of the invention, the transaction data 10, exposure data 20, an entity data 25 are obtained from an account information datastore 5 which includes account information (e.g., for bank accounts) for customers of the institution for which the comprehensive exposure analysis is being performed.

The transaction data 10 generally includes any data available to the institution about any transaction between two or more entities. In one embodiment, the transaction data includes financial transaction data, such as information about direct deposit, Automated Clearing House (ACH), purchase, sale, payment, transfer, deposit, bill-pay, loan, payroll, or other transaction. For example, in one embodiment of the invention, the institution conducting for which the comprehensive exposure analysis is being conducted is a financial institution, such as a bank, and the transaction data 10 includes information about one or more different types of transactions in which the financial institution was directly or indirectly involved.

The exposure data 20 generally includes information about the institution's exposure to one or more entities with respect to one or more different areas. For example, in one embodiment, the exposure analysis involves an analysis of an institution's credit exposure. As used herein “credit exposure” relates to the institution's exposure to a particular entity or group of entities with regard to loans and/or lines of credit provided or extended to the particular entity, group of entities, and/or related entities. In such an example, the exposure data 20 may include, for example, the amount of a loan extended to an entity, the amount of a line of credit extended to an entity, the current balance of a loan or line of credit, payments due on a loan or line of credit, payments overdue on a loan or line of credit, interest rates or interest due on a loan or line of credit, terms lengths of a loan, and/or any other information about loans or lines of credit and terms thereof. In another example embodiment, the exposure analysis involves an analysis of an institution's revenue exposure. As used herein “revenue exposure” relates to the institution's exposure to a particular entity or group of entities with regard to revenue received from the particular entity, group of entities, and/or related entities. In such an example, the exposure data 20 may include, for example, an amount of revenue or profit received by the institution from an entity, a percentage of revenue or profit received by the institution from an entity, information about revenue or profit received by the institution from an entity overall or in a particular area of the institution's business (e.g., revenue a bank receives in interest and/or fees, revenue a bank receives from mortgage products, revenue a bank receives from consumer deposit accounts, etc.). The data can include past, current, and/or projected data.

The entity data 25 generally includes other data that the institution or system 30 has about one or more entities. For example, the entities may be customers of the institution and the entity data may include entity characteristic information such as FICO score, geographical location(s), household information, age, sex, industry, sector of economy, credit history, credit score or other rating, product preferences, other preferences, size in term of employees or financial characteristics, etc.

As described above, the comprehensive exposure analysis system 30 includes memory 60. As used herein, “memory” includes any computer readable medium (as defined herein below) configured to store data, code, and/or other information. The memory 60 may include volatile memory, such as volatile Random Access Memory (RAM) including a cache area for the temporary storage of data. The memory 220 may also include non-volatile memory, which can be embedded and/or may be removable. The non-volatile memory can additionally or alternatively include an electrically erasable programmable read-only memory (EEPROM), flash memory or the like. The memory 60 may be made up of a single device or multiple devices that may or may not be coupled together. In other words, although the memory 60 is illustrated in FIG. 1 as one block in the block diagram, the memory 60 may comprise one or more separate systems/devices that perform the functions of the memory 60 described herein.

The memory 60 can store any of a number of applications which comprise computer-executable instructions/code executed by the processor 50 to implement the functions of the comprehensive exposure analysis system 30, user interface system 70, and/or other systems described herein. For example, as illustrated in FIG. 1, the memory 60 may include an exposure analysis application 65. The exposure analysis application 65 generally includes computer-executable code/instructions for using the transaction data 10 and/or the exposure data 20 to perform a comprehensive exposure analysis such as code for instructing the processor 50 to perform one or more of the functions, steps, or procedures described in one or more of FIGS. 1-9. The exposure analysis application 65 may also instructions for presenting a graphical user interface (GUI) on the display device 72 of the user interface 70 that allows a user to communicate with the comprehensive exposure analysis system 30.

The memory 60 can also store any of a number of pieces of information/data used or produced by the comprehensive exposure analysis system 30 and/or the user interface system 70 as well as the applications and devices that make up the comprehensive exposure analysis system 30 and/or the user interface system 70 to implement the functions of the comprehensive exposure analysis system 30, the user interface system 70, and/or other systems described herein. For example, as illustrated in FIG. 1, the memory 60 generally includes a datastore of comprehensive exposure metrics 68 generated by the comprehensive exposure analysis system 30. The memory 60 may also include such data as user preferences information, user-defined rules, and user selections.

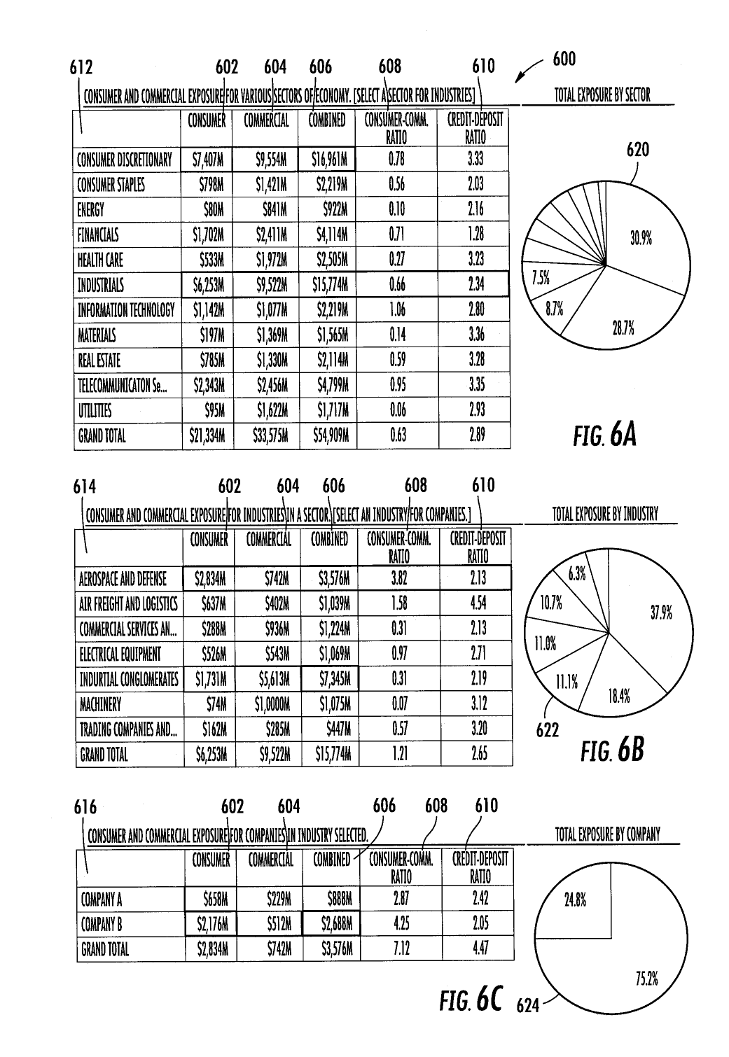

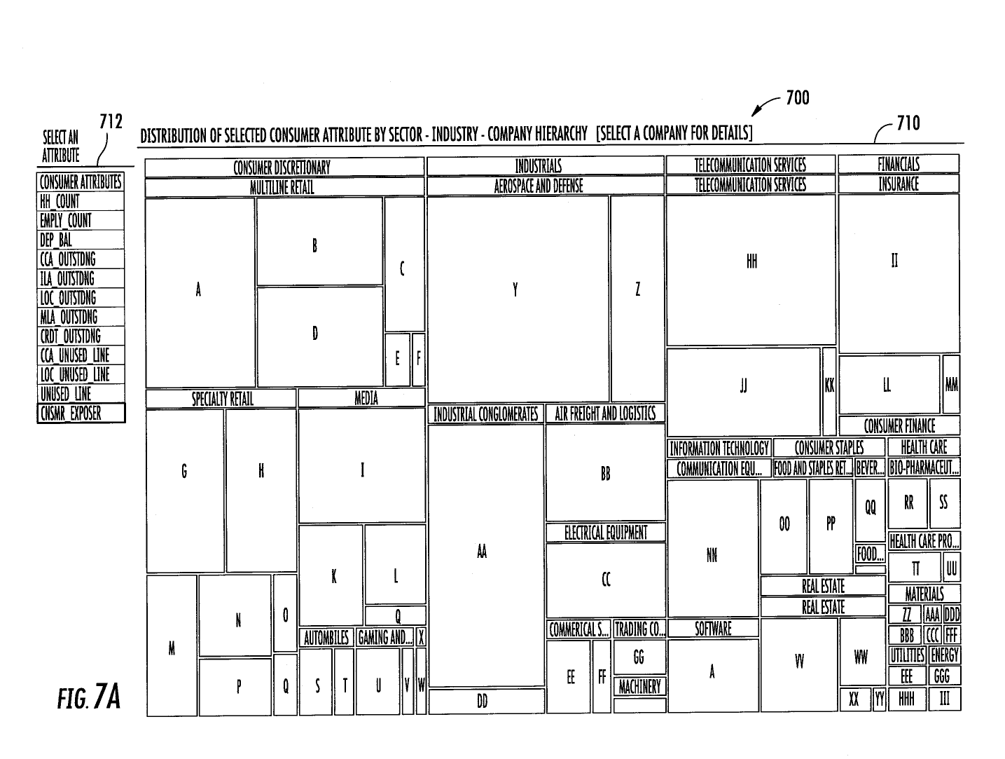

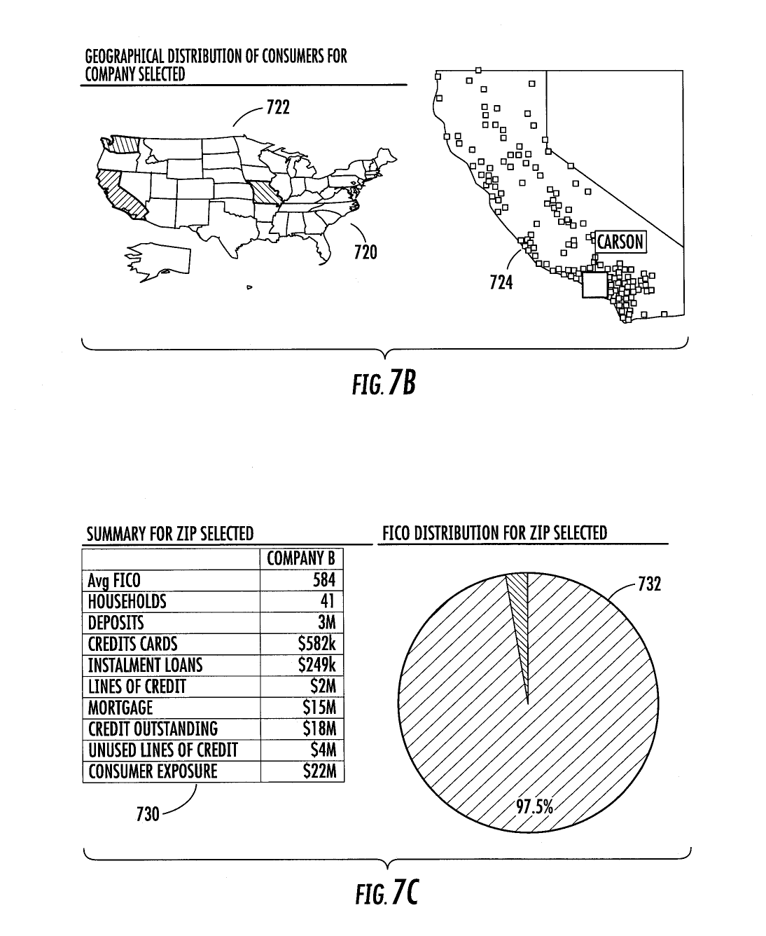

The comprehensive exposure metrics 68 generally include any information about the institution's exposure (e.g., in terms of credit, revenue, or the like) to one or more entities and/or related entities. For example, the comprehensive exposure metrics 68 may include information about product use associated with the entity or group of entities, such as but not limited to the amount or number of deposits, credit cards, installment loans, lines of credit, mortgages, credit outstanding, unused lines of credit, and/or the like that are used by the entity, group of entities, and/or related entities associated with the entity or group of entities. The comprehensive exposure metrics 68 may also include information about consumer exposure (e.g., individuals' exposure), commercial exposure (e.g., company's exposure), combined commercial and consumer exposure, consumer-commercial ratio, credit-deposit ratio, total exposure, weighted exposure, etc. The metric 68 may also include aggregated data about the entity, group of entities, and/or related entities such as number of households, number of individuals, average FICO score of individuals, geographic distribution information, geographic density information, Metrics may be aggregated, weighted, and/or culled for double-counting to present totals by sector, industry, geographical indicator (e.g., country, region, state, county, city, town, village, zip code, area code, street, neighborhood, GPS coordinates, other geocode boundaries, and/or the like), company, group of companies, individual, group of individuals, product, group of products, and/or the like. Some example metrics 68 are illustrated in and described with reference to FIGS. 6A-6C and 7A-7C.

The processor 50 of the comprehensive exposure analysis system 30, and any other processors described herein, generally include circuitry for implementing communication and/or logic functions of the system in which the processor resides, such as the comprehensive exposure analysis system 30 and/or the user interface system 70. For example, the processor 50 may include a digital signal processor device, a microprocessor device, and various analog to digital converters, digital to analog converters, and/or other support circuits. Control and signal processing functions of the system are allocated between these devices according to their respective capabilities. The processor 50, thus, may also include the functionality to encode and interleave messages and data prior to modulation and transmission. Further, the processor 50 may include functionality to operate one or more applications/software programs, which may be stored in the memory 60, such as the exposure analysis application 65. The processor 50 may be made up of a single device or multiple devices that may or may not be coupled together. In other words, although the processor 50 is illustrated in FIG. 1 as one block in the block diagram, the processor 50 may comprise one or more separate systems/devices that perform the functions of the processor 50 described herein.

As described in more detail below, the user interface system 70 may be used to present the comprehensive exposure metrics 68 to a user, as described in greater detail below. For example, in response to user input entered through the user interface system 70, certain comprehensive exposure metrics for certain entities or groups of entities may be displayed to a user in various ways via the display device 72. For example, in some embodiments of the invention, the interfaces of FIGS. 7-12 are provided to a user via the display device 72 and the user interface system 70. The comprehensive exposure metrics 68 may then be used by the user to assess risk and/or identify business opportunities that may then prompt action on behalf of the institution. In some embodiments of the invention, the comprehensive exposure metrics 68 may then be plugged into another computer system or algorithm of the comprehensive exposure analysis system 30 in order to automatically take action based on the metrics and certain pre-defined rules.

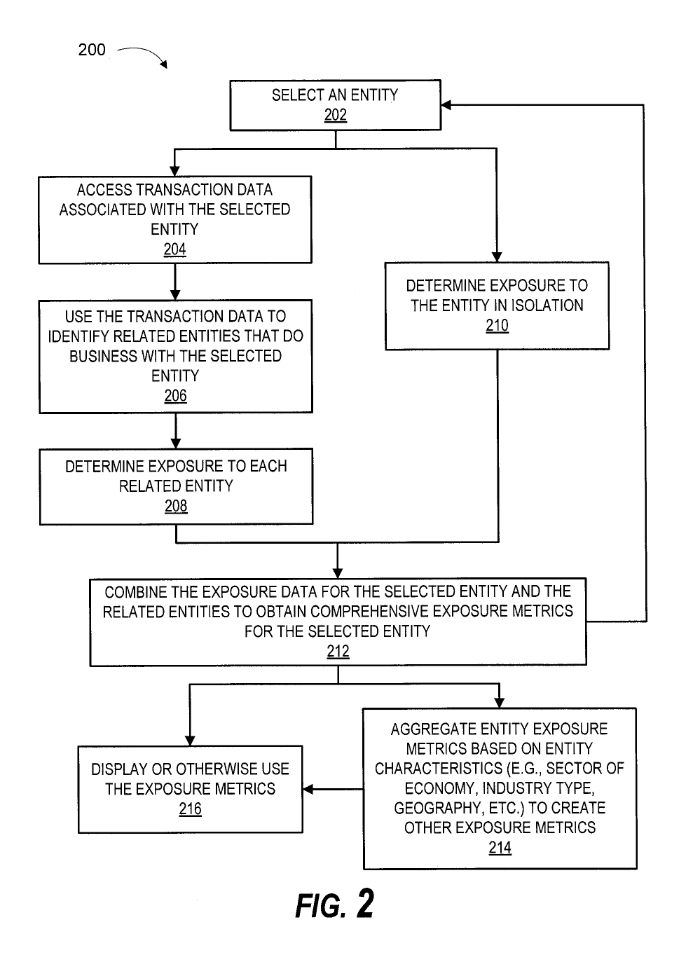

FIG. 2 provides a flow diagram illustrating a method 200 of performing a comprehensive exposure analysis for an institution in accordance with an embodiment of the present invention. For example, in some embodiments of the invention the method 200 is performed by or using the system 30 described in FIG. 1. In particular, in some embodiments, the steps of the method 200 are encoded in computer-executable program code (i.e., computer-readable instructions) of the exposure analysis application 65 and this code is executed by the processor 50 using, for example, it's processing components, the communication interface 40, the memory 60, the datastores 10 and 20, and/or the user interface system 70.

As illustrated by block 202 in FIG. 2, the method 200 generally includes selecting an entity. As used herein, the term “entity” refers to any individual or institution. As used herein, the term “institution” refers to any company, corporation, business, partnership, organization, agency, administration, group of individuals, or the like. For example, in one embodiment of the invention, the method involves the processor 50 selecting an entity by accessing the transaction data 10, exposure data 20, and/or entity data 25 and using the data to select a customer of the institution for which the exposure analysis is being performed (e.g., a company or individual that has an account with or uses a product of the institution). In another embodiment of the invention, the processor 50 selects an entity 202 based on user input received from a user via the user interface system 70, where the user input includes an indication of a user-selected entity.

As illustrated by block 210, the method 200 further involves determining an institution's exposure to the selected entity in isolation. In one embodiment of the invention, the processor 50 determines the institution's exposure to the selected entity in isolation by accessing the exposure data 20 and determining the institution's direct exposure to the selected entity. For example, where the selected entity is a company and where the exposure analysis includes an analysis of the institution's credit exposure to the selected company, the exposure data 20 may comprise loan and/or line of credit account information for the institution's customers including the selected company. In such an example, the processor 50 may look through the account information to identify all of the current balances for the loans and/or lines of credit held by the selected company. The processor 50 may then sum all of the identified balances to obtain a monetary amount representing the institution's total direct credit exposure to the selected company. It will be appreciated by one of ordinary skill in the art that this is just an example and that other ways of calculating direct credit exposure may vary in other embodiments of the invention. Furthermore, similar methods may be performed with regard to revenue in order to calculate direct revenue exposure to the selected company or other entity.

As described briefly above, embodiments of the invention also use transaction data to automatically determine one or more other entities that are regular business partners (i.e., “related entities”) of the selected entity and then calculate the institution's exposure to the selected entity based at least partially on the institution's exposure to these one or more related entities. In this regard, blocks 204-212 illustrate an example of a process for determining related entities and using these related entities in the exposure analysis of the selected entity.

More particularly, as illustrated by block 204, the method 200 includes accessing transaction data associated with the selected entity. For example, in one embodiment of the invention, the processor 50 access the transaction data 10 to identify one or more transactions, such as financial transactions: (1) in which the institution was involved or has knowledge, and (2) that are transactions between the selected entity and another entity. Where the selected entity is a company, the transactions may include, for example, direct deposit transactions or other ACH transactions since these transactions are often likely to be made with an employee, supplier, distributor, or other business partner. In some embodiments, the processor 50 identifies all transactions in the datastore 10 that involve the selected entity, while in other embodiments of the invention the processor identifies only those transactions that are a particular defined type of transaction and/or occur with a certain pre-determined frequency/regularity.

As illustrated by block 206, the method 200 then involves using the transaction data accessed in the process represented by block 204 to identify related entities that do business with the selected entity. In some embodiments, this process involves identifying the party opposite the selected entity in all of the transactions identified in the process represented by block 204. In other embodiments, this process involves analyzing the transaction data associated with the selected entity and identifying only those other “related” entities that perform certain pre-defined types of transactions that also occur above a pre-defined frequency threshold. In other words, some embodiments of the invention analyze the transaction data to only identify as related entities those entities that rely significantly on the selected entity financially so as to warrant considering these entities in the exposure analysis of the selected entity. For example, the rules may be created to attempt to automatically identify the selected entity's employees, suppliers, distributors, retailers, manufacturers, customers, employers, affiliates, and/or other business partners so that these entities can be particularly included or excluded from the exposure analysis of the institution's exposure to the selected entity.

For example, in some embodiments of the invention, the exposure analysis application 65 has rules defining the requirements of related entities in one or more contexts. In some embodiments, these rules can be created or modified by a user of the user interface system 70. In some embodiments, the rules include transaction type requirements that instruct the processor 50 to identify those transactions that are of a particular type and then use those identified transactions to identify related entities. For example, suppose that the comprehensive exposure analysis system 30 is being used to conduct a credit exposure analysis for an institution and, as such, the user desires to identify the institution's credit exposure to a company that includes an analysis of the institution's credit exposure to the company's employees. In such an example, the exposure analysis application 65 may include a rule instructing the processor 50 to identify the entity on the other end of a transaction with the selected company, but only if the transaction is a direct deposit transaction from the company to the entity.

In some embodiments, the rules include transaction requirements that instruct the processor 50 to identify those transactions that occur with a particular frequency and then use those identified transactions to identify related entities. The frequency may be defined by a number of overall transactions or by a number of transactions within a particular period of time. For example, the frequency requirement may instruct the processor 50 to identify entities as related entities if they transact a certain type(s) of transaction with the selected entity greater than a predefined number of times where the predefined number of times may be any number greater than zero. In another example, the frequency requirement may instruct the processor 50 to identify entities as related entities if they transact a certain type(s) of transaction with the selected entity greater than a predefined number of times within a predefined time period, where the predefined time period may be a year, quarter, month, two weeks, week, day, hour, minute, or any other time period. The frequency requirement may also be defined by a percentage of the selected entity's transactions and/or of the related entity's transactions (e.g., related entities may include only those entities that account for greater than 5% of the selected entity's total transactions). The frequency requirement may be defined using an integer or percentage threshold where the processor is instructed to identify those transactions that occur with a frequency equal to, above, and/or below the integer or percentage. The frequency requirement may be defined using an integer or percentage range where the processor is instructed to identify those transactions that occur with a frequency either inside or outside the range. Such a threshold or range may be created by a user using the user interface system 70 or may be dynamically created by the processor 50 based on the transaction data 10 and certain rules (e.g., neural network rules or other artificial intelligence rules) for dynamically generating the threshold or range. The frequency requirement may be applied to all transactions with a particular entity to see if the transactions between a particular entity and the selected entity generally satisfy the pre-defined frequency requirements, or the frequency requirement be applied only to those transactions with a particular entity that are of a particular type and/or size to see if these particular transactions meet the pre-defined frequency requirements. For example, in the example where the comprehensive exposure analysis system 30 is configured to identify the institution's credit exposure to a company that includes an analysis of the institution's credit exposure to the company's employees, the exposure analysis application 65 may include a rule instructing the processor 50 to identify the entity on the other end of a transaction with the selected company, but only if the transaction is a direct deposit transaction from the company to the entity and only if the direct deposit occurs with a frequency equal or greater than once per month.

In some embodiments, the rules include transaction requirements that instruct the processor 50 to identify those transactions that are of a pre-defined size (e.g., are for a pre-defined amount of money) and then use those identified transactions to identify related entities. The size requirement may be defined using an integer or percentage threshold where the processor is instructed to identify those transactions that are of a size equal to, above, and/or below the integer or percentage. The size requirement may be defined using an integer or percentage range where the processor is instructed to identify those transactions that are of a size either inside or outside the range. Such a threshold or range may be created by a user using the user interface system 70 or may be dynamically created by the processor 50 based on the transaction data 10 and certain rules (e.g., neural network rules or other artificial intelligence rules) for dynamically generating the threshold or range. The size requirement may be applied to all transactions with a particular entity to see if any transactions between a particular entity and the selected entity satisfy the pre-defined size requirements, or the size requirement may be applied only to those transactions with a particular entity that are of a particular type and/or frequency to see if these particular transactions meet the pre-defined size requirements. For example, in an example where the comprehensive exposure analysis system 30 is configured to identify the institution's credit exposure to a company that includes an analysis of the institution's credit exposure to the company's largest suppliers, the exposure analysis application 65 may include a rule instructing the processor 50 to identify the entity on the other end of a transaction with the selected company, but only if the transaction is a payment transaction (e.g., a check or ACH) from the company to the entity, only if the transaction occurs with a frequency equal or greater than once per quarter, and only if the transaction is greater than or equal to two hundred thousand dollars.

As illustrated by block 208, the method 200 then involves determining the institution's exposure to each of the related entities identified in the process represented by block 206. For example, in one embodiment of the invention, the processor 50 accesses the exposure data 20 and searches for and obtains any exposure data associated directly with a related entity. Whether there is any relevant exposure data 20 directly associated with the related entity will depend on whether the related entity is a customer of the institution and, even if the related entity is a customer, whether the related entity uses any products of the financial institution relevant to the particular exposure analysis being performed. In some embodiments of the invention, the processor accessing the exposure data involves first comparing the related entities to an overall institution customer list or with a product-specific customer list before trying to obtain exposure data for a related entity in order to identify whether there will be any relevant exposure data 20 for the particular related entity. In other embodiments, the processor 50 could instead just try to get exposure data for the related entity from the exposure data datastore 20 and receive a null value if nothing is in the datastore 20 associated with the particular related entity and/or relevant to the particular exposure analysis. Once received, the processor 50 may temporarily store the relevant exposure data of each of the related entities in memory 60 so as to perform the herein-described operations on the data.

In some embodiments, the processor 50 reviews exposure data associated with each related entity to determine whether the exposure data is relevant to the particular exposure analysis being performed. Whether certain exposure data is relevant may depend on the type of data (e.g., credit or revenue data, etc.) or the type of product (e.g., home loan, car loan, home equity line of credit, credit card line of credit, revolving credit, revenue from deposit account, revenue from credit account, revenue from transaction fees, revenue from late fees, etc.). Relevancy of exposure data may also depend on other rules, which rules may or may not be user-defined or user-modifiable. For example, relevancy may also be based on the size of the exposure (e.g., small exposure below a particular threshold may be considered negligible or insignificant for some exposure analyses), the size of the related entity, the size of the selected entity, the type of related entity, the type of selected entity, and/or the relationship between the selected entity and the related entity.

As illustrated by block 212, the method 200 then involves combining the exposure data for the selected entity (i.e., the exposure data determined from the process represented by block 210) and/or the exposure data for one or more of the related entities (i.e., the exposure data determined from the process represented by blocks 204-208) to obtain comprehensive exposure metrics 68 for the selected entity. For example, the comprehensive exposure metrics 68 may include such metrics as the total exposure, total weighted exposure, total exposure of all related entities (e.g., exposure to consumer accounts of all employees of the selected entity), total exposure of the selected entity, ratio of the total exposures of the selected and related entities, credit to debit ratios for these entities or groups of entities, average exposure to related entities, relative exposure percentages of the entities or groups of entities, number or percentage of related entities associated with the selected entity to which the institution is or is not exposed, and/or the like. In some embodiments, the processor 50 performs the calculations and stores the comprehensive exposure metrics 68 in the memory 60.

In some embodiments, the exposure metrics are simply totaled or averaged across related entities and/or across the related and selected entities. In other embodiments, the exposure metrics are weighted before they are totaled or averaged based on the related entity, exposure, selected entity, number of related entities, and/or relationship between the selected and related entity. For example, if the selected entity supplies to a related entity almost all of the related entity's revenue, then perhaps a loan or line of credit extended to the related entity should be counted 100% in the credit exposure analysis of the selected entity because if the selected entity were to fail and default on its loans, the loans of the related entity, which receives almost all of its revenue from the selected entity, would very likely also default. However, in other situations it may be useful to count the exposures to one or more related entities less relative to other exposures to obtain a more accurate risk rating for a selected entity.

In other embodiments when determining the exposure of a selected entity and the related entities it may be helpful to drill down into the exposure of secondary related entities. For example, if a related entity has forty (40) percent of its exposure from the selected entity and the other sixty (60) percent from other entities (i.e. secondary related entities) it may be helpful to identify the credit exposure of a related entity based on the selected entity and secondary related entities. Therefore, in some embodiments the metrics are tracked for the exposure of a related entity based on the selected entity and secondary related entities in the same ways as described herein for tracking the metrics for the selected entity based on the related entities.

It should be appreciated that, in some embodiments of the invention, only the exposure data for the plurality of related entities are combined together and are not combined with any exposure data of the selected entity when comprehensive exposure metrics are being generated. For example, in a product exposure analysis for a bank that is attempting to view the success of marketing and possible marketing opportunities, embodiments of the present invention may be used to identify all of the employees and contractors of a selected company and identify which percentage of these customers are customers of the bank with regard to a particular product (i.e., the bank's “product exposure” to the selected company's employees for a particular product). If the percentage is low, perhaps the bank could offer a group banking program to the company for the company to offer as an employee benefit. This may then incentivize more employees to use banking products. On the other hand, if the percentage is high, then the bank may want to use its resources to target other companies or marketing efforts.

As illustrated by block 216, the method 200 may then involve displaying or otherwise using the comprehensive exposure metrics obtained from the process represented by block 212. In some embodiments of the invention, the exposure analysis application 65 includes computer-executable program code for a graphical user interface (GUI) that the processor 50 communicates, via the communication interface 40, to the display device 72 of the user interface system 70. For example, FIGS. 6C, 7B, and 7C illustrate example user interfaces that present example comprehensive exposure metrics for a selected entity.

As illustrated in FIG. 2, in some embodiments of the method 200, the process represented by blocks 202-212 may be repeated for numerous different entities to obtain comprehensive exposure metrics 68 for each of the different selected entities. As illustrated by block 214, in some such embodiments, the method 200 further involves aggregating the comprehensive exposure metrics 68 for several of the different selected entities based on entity characteristics to create other exposure metrics 68. Examples of entity characteristics include, for example, but are not limited to, the sector of the economy in which the entity exists, the industry type of the entity, the geographical location(s) of the entity, and/or the like. Entity characteristics may be determined from the entity data datastore 25. Embodiments of the invention could include weighting or exclusion methods that could avoid double counting of the institution's exposure to related entities where the related entities are related to a number of different entities being summed together. In other embodiments, however, entities and the exposure thereto may be double counted in the aggregations.

As illustrated by block 216, the method 200 may then involve displaying or otherwise using the exposure metrics generated from the process represented by block 214. For example, FIGS. 6A-7C illustrate example user interfaces that present example comprehensive exposure metrics for a groups of selected entities.

Once the metrics are created, they may be acted on by the institution to affect marketing, underwriting, reporting, strategizing, and/or the like. In some embodiments of the invention, the comprehensive exposure metrics 68 may be automatically communicated by the comprehensive exposure system 30 to one or more other such decision making systems where automated and/or manual decisions may be made based thereon.

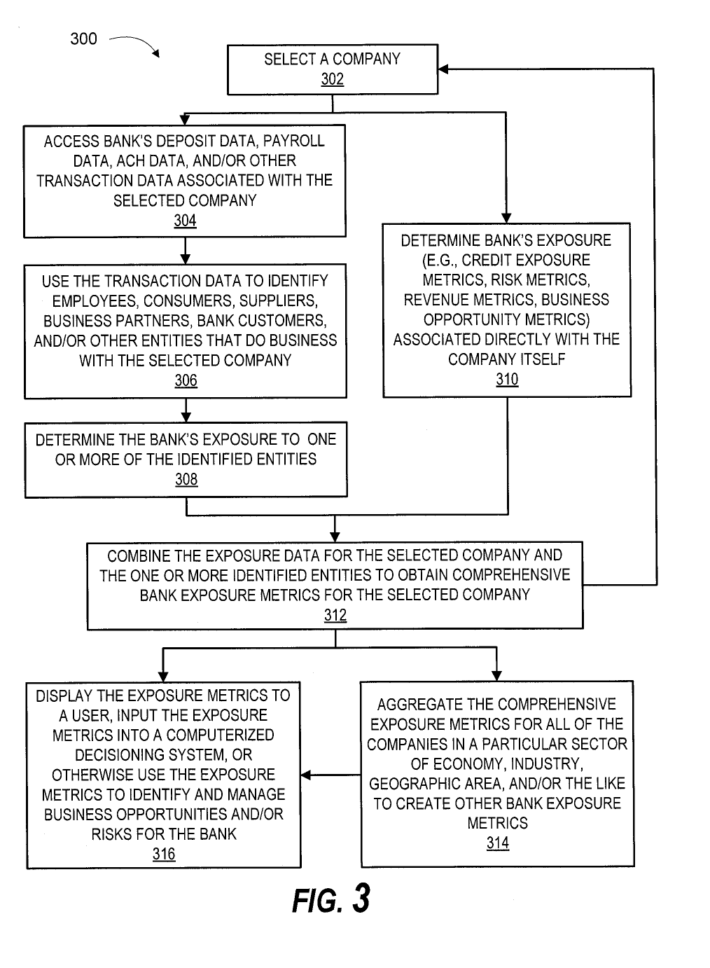

FIG. 3 provides a flow diagram illustrating an example embodiment 300 of the method 200 of FIG. 2. In this example embodiment 300, a bank uses its transaction data associated with a particular company along with exposure metrics of the company and other bank customers to perform a comprehensive exposure analysis regarding the bank's exposure to the company. However, it will be understood in view of this disclosure that FIG. 3 is just a mere example of the process with respect to FIG. 2 and that the description of FIG. 2 is not limited by the description of FIG. 3.

In some embodiments of the invention, the method 300 is performed by or using the system 30 described in FIG. 1. In particular, in some embodiments, the steps of the method 300 are encoded in computer-executable program code (i.e., computer-readable instructions) of the exposure analysis application 65 and this code is executed by the processor 50 using, for example, it's processing components, the communication interface 40, the memory 60, the datastores 10 and 20, and/or the user interface system 70.

As illustrated by block 302 in FIG. 3, the method 300 generally includes selecting a company. For example, in one embodiment of the invention, the method involves the processor 50 selecting a company by accessing the transaction data 10, exposure data 20, and/or entity data 25 associated with the bank's commercial accounts and using the data to select a commercial customer of the bank (e.g., a company that has an account with or uses a product of the bank). In another embodiment of the invention, the processor 50 selects a company based on user input received from a user via the user interface system 70, the user input including a user-selected company.

As illustrated by block 310, the method 300 further involves determining the bank's exposure (e.g., credit exposure metrics, risk metrics, revenue metrics, business opportunity metrics, etc.) associated directly with the company itself. In one embodiment of the invention, the processor 50 determines the bank's exposure to the selected company in isolation by accessing the exposure data 20 and determining the bank's direct exposure to the selected company. For example, where the selected entity is a company and where the exposure analysis includes an analysis of the bank's credit exposure to the selected company, the exposure data 20 may comprise loan and/or line of credit account information for the bank's customers including the selected company. In such an example, the processor 50 may look through the account information to identify all of the current balances for the loans and/or lines of credit held by the selected company. The processor 50 may then sum all of the identified balances to obtain a monetary amount representing the bank's total direct credit exposure to the selected company. It will be appreciated by one of ordinary skill in the art that this is just an example and that other ways of calculating direct credit exposure may vary in other embodiments of the invention. Furthermore, similar methods may be performed with regard to revenue to calculate direct revenue exposure to the selected company or other entity.

As illustrated by block 304, the method 300 includes accessing the bank's deposit data, payroll data, ACH data, and/or other transaction data associated with the selected company. For example, in one embodiment of the invention, the processor 50 accesses the transaction data 10 to identify one or more transactions, such as financial transactions, in which the institution was involved or otherwise has knowledge of and that are transactions between the selected company and another entity. In some embodiments, the processor 50 identifies all transactions in the datastore 10 that involve the selected company, while in other embodiments of the invention the processor identifies only those transactions that are a particular defined type of transaction and/or occur with a certain frequency/regularity. In some embodiments of the invention, the transaction data is obtained from the selected company's account with the bank. In other embodiments, however, the transaction data is obtained from other customers' accounts where the transactions are between those customers and the selected company. As such, even if a selected company is not a customer of the bank, some embodiments of the invention can still analyze the bank's exposure to the selected company by virtue of the bank's exposure to related companies that may rely on or do business with the selected company.

As illustrated by block 306, the method 300 then involves using the transaction data to identify employees, consumers, suppliers, business partners, company customers, bank customers, and/or other entities that do business with the selected company. As illustrated by block 308, the method 300 then involves determining the bank's exposure to each of the related entities identified in the process represented by block 306.

As illustrated by block 312, the method 300 then involves combining the exposure data for the selected company (i.e., the exposure data determined from the process represented by block 310) and/or the exposure data for one or more of the related entities (i.e., the exposure data determined from the process represented by blocks 304-308) to obtain comprehensive exposure metrics 68 for the selected company. As illustrated in FIG. 3, in some embodiments of the method 300, the process represented by blocks 302-312 may be repeated for numerous different companies to obtain comprehensive exposure metrics 68 for each of the different selected companies. As illustrated by block 314, in some such embodiments, the method 300 further involves aggregating the comprehensive exposure metrics 68 for several of the different selected companies based on entity characteristics to create other exposure metrics 68. Examples of entity characteristics include, for example, but are not limited to, the sector of the economy in which the company exists, the industry type of the company, the geographical location(s) of the company, and/or the like. Embodiments of the invention could include weighting or exclusion methods that avoid double counting of the bank's exposure to related entities where the related entities are related to a number of different companies being summed together. In other embodiments, however, entities and the exposure thereto may be double counted in the aggregations.

As illustrated by block 316, the method 300 may then involve displaying the exposure metrics 68 resulting from the process represented by block 312 and/or 314 to a user via the user interface system 70, inputting the exposure metrics into a computerized decisioning system via the communication interface 40, or otherwise using the exposure metrics 68 to identify and manage business opportunities and/or risks for the bank. For example, FIGS. 6A-7C illustrate example user interfaces that present example comprehensive exposure metrics for a groups of selected companies.

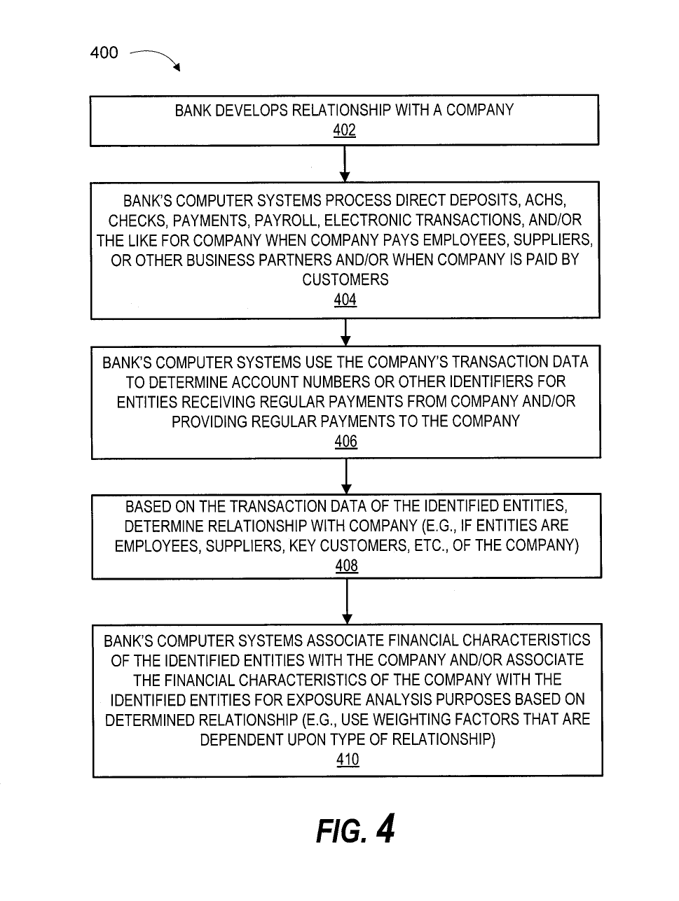

FIG. 4 provides a flow diagram illustrating a particular method 400 of performing a comprehensive exposure analysis for a company in accordance with an example embodiment of the invention. As illustrated by block 402, a bank (or other financial institution) develops a relationship with the company. For example, the company may open a business account with the bank or hire the bank to manage or process certain of its financial transactions.

As illustrated by block 404, the bank's computer systems process direct deposits, other ACHs, checks, payments, payroll, and/or other transactions for the company when the company pays employees, suppliers, distributors, or other business partners and/or when the company is paid by customers, distributors, and/or other business partners. In some embodiments, the transactions are electronic transactions and the transaction information is automatically stored in memory of the bank's computer systems. In other embodiments, the transactions may not be electronic, but electronic information about the transactions may be created and then stored in the memory of the bank's computer systems. Transaction information may include information about the other entity (e.g., the payor or payee) opposite the company in the transaction. Such information may include identifying information such as a name, address, account number, payment device number, and/or other identifier for the entity opposite the company. Transaction information may also include information about the transaction including financial information, such as amount, currency, payment terms, etc., and non-financial information, such as descriptions of goods or services being transferred, description of transaction, type of transaction, date of transaction, and/or the like. This transaction data is stored and associated with the company in the memory of the bank's computer system.

As illustrated by block 406, the bank's computer systems (such as the system described with reference to FIG. 1) then use the company's transaction data to determine account numbers or other identifiers for entities receiving regular payments from the company and/or providing regular payments to the company. As represented by block 408, based on the transaction data of the identified entities, the bank's computer systems then determine the relationship between each identified entity and the company (e.g., if entities are employees, suppliers, distributors, key customers, etc., of the company). For example, where an individual (e.g., a consumer account customer of the bank) receives repeated payments from the company every week, two weeks, bi-monthly, or monthly and the amount is within a particular range and rarely varies or varies only slightly within a small range, then the entity may be determined by the system to be an employee of the company.

As represented by block 410, the bank's computer systems then associate financial characteristics of the identified entities with the company and/or associate the financial characteristics of the company with the identified entities for exposure analysis purposes based on the determined relationship. For example, loans and lines of credit that the bank has extended to the company's employees may be at least partially counted or viewed in the bank's analysis of its exposure to the company overall. The bank's exposure to the company may also be considered when analyzing the bank's exposure to the individual. In some embodiments, weighting factors are used to reduce or increase the weight of the bank's exposure to each related entity or group of related entities relative to the weight put on the company's own exposure or the weight put on other related entities or groups of entities. These weighting factors may be based on the type of relationship between the company and the related entity, as well as on the type of exposure.

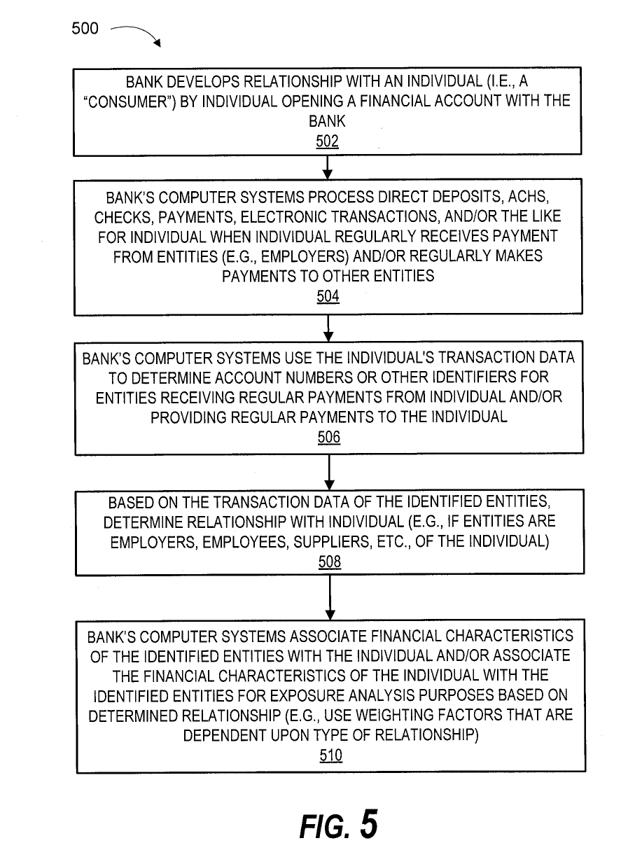

FIG. 5 provides a flow diagram illustrating a particular method 500 of performing a comprehensive exposure analysis for an individual in accordance with an example embodiment of the invention. As illustrated by block 502, the bank develops a relationship with an individual (i.e., a “consumer”) by the individual opening a financial account with the bank. For example, the individual may open a consumer account with the bank or have a credit account with the bank by virtue of a loan or line of credit owned or managed by the bank.

As illustrated by block 504, the bank's computer systems process direct deposits, other ACHs, checks, payments, payroll, and/or other transactions for the individual when the individual regularly receives payment from entities (e.g., employers) and/or regularly makes payments to other entities. In some embodiments, the transactions are electronic transactions and the transaction information is automatically stored in the memory of the bank's computer systems. In other embodiments, the transactions may not be electronic, but electronic information about the transaction may be created and then stored in the memory of the bank's computer systems. Transaction information may include information about the other entity (e.g., the payor or payee) opposite the individual in the transaction. Such information may include identifying information such as a name, address, account number, payment device number, and/or other identifier for the entity opposite the individual. Transaction information may also include information about the transaction including financial information, such as amount, currency, payment terms, etc., and non-financial information, such as descriptions of goods or services being transferred, description of transaction, type of transaction, date of transaction, and/or the like. This transaction data is stored and associated with the individual in the memory of the bank's computer system.

As illustrated by block 506, the bank's computer systems (such as the system described with reference to FIG. 1) then use the individual's transaction data to determine account numbers or other identifiers for entities receiving regular payments from the individual and/or providing regular payments to the individual. As represented by block 508, based on the transaction data of the identified entities, the bank's computer systems then determine the relationship between each identified entity and the individual (e.g., if entities are employers, employees, suppliers, service providers, etc., of the individual). For example, where an individual (e.g., a consumer account customer of the bank) receives repeated payments from an entity every week, two weeks, bi-monthly, or monthly and the amount is within a particular range and rarely varies or varies only slightly within a small range, then the entity may be determined by the system to be an employer of the individual.

As represented by block 510, the bank's computer systems then associate financial characteristics of the identified entities with the individual and/or associate the financial characteristics of the individual with the identified entities for exposure analysis purposes based on the determined relationship. For example, loans and lines of credit that the bank has extended to the individual may be at least partially counted or viewed in the bank's analysis of its exposure to the individual's employer because the employer failing would also put the loans given to employees at greater risk of default. The bank's exposure to the employer may also be considered when analyzing the bank's exposure to the individual. In some embodiments, weighting factors are used to reduce or increase the weight of the bank's exposure to each related entity or group of related entities relative to the weight put on the individual's own exposure or the weight put on other related entities or groups of entities. These weighting factors may be based on the type of relationship between the individual and the related entity, as well as on the type of exposure.

FIG. 6A provides an exposure analysis interface 600 illustrating an example chart and graph of a financial institution's total exposure to a particular user-selected sector of the economy, in accordance with an embodiment of the present invention. FIG. 6A illustrates a breakdown of the financial institution's consumer credit exposure 602 (financial institution's exposure to individuals with consumer accounts that are related to businesses in the sector), the commercial credit exposure 604 (financial institution's exposure to businesses with commercial accounts that are related to businesses in the sector), the combined credit exposure 606, consumer-commercial exposure ratio 608, and credit-deposit ratio 610, for various sectors listed in the sector column 612. As illustrated in FIG. 6A, Company A is part of the industrials sector. The exposure analysis interface 600 illustrates that the consumer credit exposure 602 for the industrials sector is approximately six billion dollars and the commercial credit exposure 604 of the industrials sector is approximately ten billion dollars, for a total credit exposure 606 of approximately sixteen billion dollars. These comprehensive exposure metrics 68 indicate that the financial institution is heavily exposed to industrials with regard to credit (i.e., loans and lines of credit) that it extends. A user can utilize this information to illustrate that the financial institution may want to try to increase its exposure in the consumer side of the industrials sector, or that it might be better to increase revenue and risk in another sector, such as the health care, energy, or information technology sectors, because the financial institution is already heavily leveraged in the industrials sector. The consumer-commercial credit exposure ratio 608 and the credit-deposit ratio 610 are other examples of comprehensive exposure metrics 68 that can also be used to evaluate whether the financial institution is over or under exposed.

FIG. 6B provides an exposure analysis interface illustrating an example chart and graph of an institution's total credit exposure by industry to a particular user-selected sector of the economy, in accordance with an embodiment of the present invention. FIG. 6B illustrates the same breakdown of the consumer credit exposure 602, the commercial credit exposure 604, the combined credit exposure 606, consumer-commercial credit exposure ratio 608, and credit-deposit ratio 610, but it relates to the specific industries within a sector chosen by a user from the list of sectors illustrated in FIG. 6A. For example, in the aerospace and defense industry of the industrials sector, the consumer credit exposure is almost three billion dollars, while the commercial exposure is only approximately seven-hundred million dollars for a combined approximate three and one-half billion dollars of exposure. Therefore, there is may be an opportunity to increase the commercial exposure in the aerospace and defense industry, or increase exposure in other industries within the industrials sector that have a lower total combined exposure 606, such as trading companies, or air freight and logistics, or a lower credit-deposit ratio 610.

FIG. 6C provides an exposure analysis interface illustrating an example chart and graph of an institution's total exposure by company to a particular user-selected industry, in accordance with one embodiment of the present invention. Specifically, FIG. 6C illustrates a chart and graph of the total exposure by company in the aerospace and defense industry, which may have been selected by a user from the interface of FIG. 6B. FIG. 6C illustrates the same comprehensive exposure metrics 68 of the consumer credit exposure 602, the commercial credit exposure 604, the combined credit exposure 606, consumer-commercial credit exposure ratio 608, and credit-deposit ratio 610, but it relates to the specific commercial customers within an industry. For example, Company B has approximately two and one-half billion dollars in combined credit exposure, while Company A has approximately nine-hundred million dollars in combined exposure. Therefore, some users may identify that perhaps they should have a marketing campaign or offer group banking discounts to Company A employees because they can afford greater consumer credit risk amongst this population. The pie graphs 620, 622, and 624 in FIGS. 6A-6B can illustrate a number of metrics; however, in the illustrated embodiment the pie graphs illustrate the percentages of the exposure for each sector, each industry in the sector, and each commercial customer in the industry, as the case may be.

FIG. 7A provides an exposure analysis interface illustrating example interface controls and an example diagram of an institution's total exposure for a particular user-selected attribute based on sector, industry, and company, in accordance with one embodiment of the present invention. The attribute chart 710 illustrates graphically the exposure of the bank to related consumer customers (e.g., employees and/or individual contractors) of commercial customers based on various attributes of the bank's consumer exposure. The user can change the attribute displayed by selecting a different attribute in the select attribute section 712. The attributes can include, but are not limited to household count (i.e., the number of households represented by the related consumer customers), employee head count, deposit balance, credit card balances outstanding, installment loan balances outstanding, lines of credit balances outstanding, mortgage loan balances outstanding, other credit balances outstanding, unused lines of credit available, other unused credit available, and total consumer exposure, as is illustrated by the attribute selection section 712 in FIG. 7A. FIG. 7A can be utilized by the user in order to identify sectors, industries, and commercial customers that may have associated risks or revenue opportunities for related consumers based on specific attributes of the consumers. For example, if Company Y in the aerospace and defense industry and the industrials sector is having financial difficulties, then the user can use the comprehensive exposure analysis system 30, and specifically the attribute chart, illustrated in FIG. 7A, to identify the exposure the bank has to related consumers of Company Y. For example, based on the total exposure attribute chart 710, Company Y has the largest exposure of total consumer exposure out of all of the other commercial customers. Therefore, if Company Y is performing poorly, it increases the total risk to bank more than if Company Z was performing poorly because of the large related consumer exposure of Company Y. The related consumers would be a higher risk to default if Company Y was having financial difficulties, because some of the related consumers might be affected by the layoffs or reductions in pay. FIG. 7A, also helps the bank identify areas to increase and reduce loans made to consumers or to increase or reduce marketing efforts for other financial products. For example, the bank may want to reduce the amount of loans provided to the aerospace and defense industry and instead increase other areas of consumer exposure by marketing loans to other consumers who work for companies in other industries and sectors that do not have as much consumer exposure, such as but not limited to in this case, the health care industry, or energy industry.

FIG. 7B provides an exposure analysis interface illustrating a geographic chart 720 of the bank's customers that are associated with (e.g., employees and/or other business partners of) a particular user-selected company, in accordance with one embodiment of the present invention. The geographic location chart 720 illustrated in FIG. 7B displays the banks exposure to related consumer customers geographically by state 722 within the United States, and areas within the states 724. For example, FIG. 7B illustrates the area in which the consumer customer exposure is the greatest and the least for Company A. For example, the bank is already heavily exposed to related consumers for Company A in California and less exposed in Washington. While this often illustrates where the majority of the population who works for Company A is located, it can also indicate areas of geographic location that the bank needs to work on expanding. For example, if the bank knows that there are a large number of employees located in Texas that work for Company A, but the geographic location chart 620 illustrates that Texas has a small amount of consumer exposure, the bank knows it needs to work on creating more consumer exposure in Texas. As previously described, the geographic location chart can illustrate the related consumer exposure by country, region, state, county, city, zip code, street address, etc. in other embodiments of the invention. Other available information can also be displayed with the exposure concentration information, such as the concentration of non-customer consumers related to the selected company (e.g., non-customer employees of the selected company).

FIG. 7C provides an exposure analysis interface illustrating a chart and graph of an institution's exposures to employees of a particular user-selected company, in accordance with one embodiment of the present invention. More particularly, FIG. 7C provides a zip code chart 730 and graph 732 of the exposure of the bank for various attributes of related consumers of a commercial customer in a particular geographic location. In one embodiment of the invention illustrated in FIG. 7C, the related consumer information is summarized for the commercial customer based on a zip code location. The zip code chart 730, in one embodiment, illustrates attributes, such as, but not limited to, the average credit score (FICO score) of related consumers, the number of related consumer households, the total deposits for related consumers, total credit card debt of related consumers, total installment loans of related consumers, total lines of credit of related consumers, total mortgage balances of related consumers, total credit outstanding of related consumers, total unused lines of credit available to related consumers, and the bank's total credit exposure to related consumers of the commercial customer in the specific geographic region.

The graph 732, in the illustrated embodiment displays the FICO distribution for a zip code location. If a user selects another attribute, the graph 732 changes to display the distribution for the selected attribute. In some embodiments, the information in the zip code chart 730 and graph 732 may be summarized by country, region, state, county, city, and/or the like instead of zip code. In some embodiments, the information may be summarized not only for related consumers of a commercial customer, as illustrated in FIG. 7C, but for multiple commercial customers, such as for related commercial customers in specific industries, multiple industries, specific sectors, or multiple sectors.

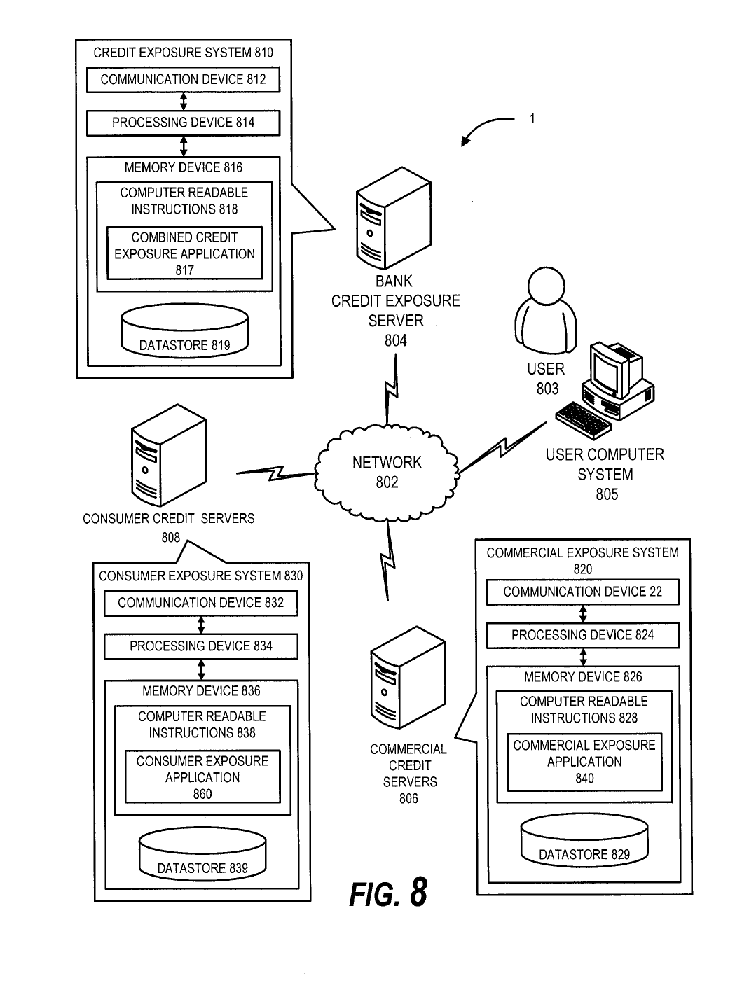

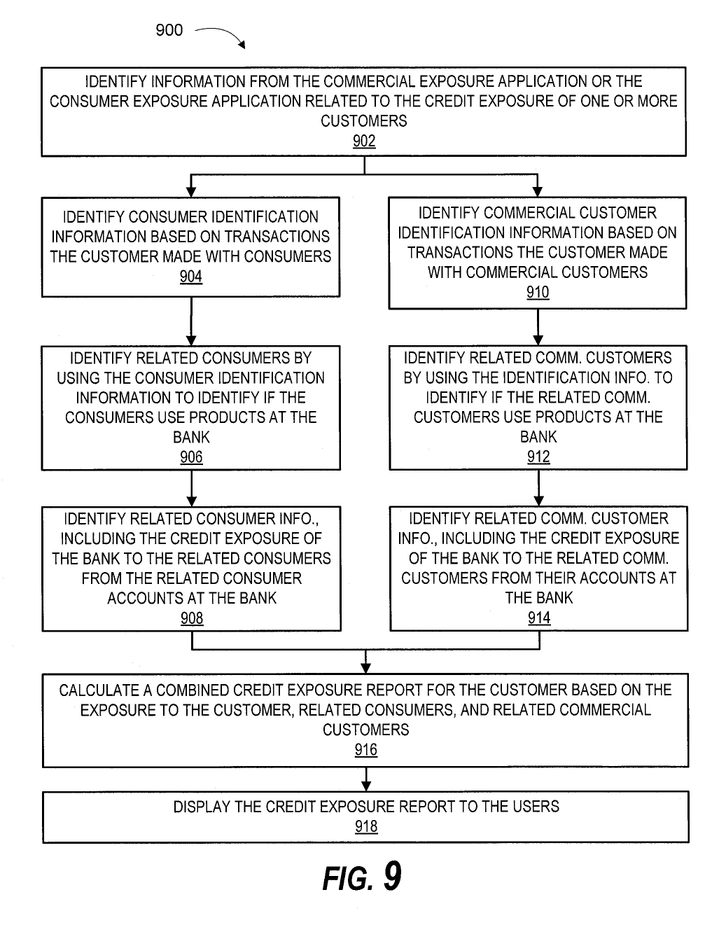

Embodiments of the invention also provide systems and methods for performing exposure analysis and/or other types of analysis for a bank or other financial institution by automatically determining the interplay between the consumer side of the bank (i.e., the accounts and other financial products provided by the bank to individuals) and the commercial side of the bank (i.e., the accounts and other financial products provided by the bank to businesses) with regard to the particular analysis being performed. FIG. 8 illustrates a particular embodiment of a combined commercial and consumer system and environment 800 in accordance with an embodiment of the present invention. It will be appreciated that FIG. 8 illustrates only one possible embodiment of the invention and that other embodiments of the invention may be structured in different ways. Nothing in FIG. 8 or 9 are intended to limit the invention described above with reference to FIGS. 1-7 unless specifically recited in the claims.

As illustrated in FIG. 8, in this example embodiment, a bank's credit exposure server 804 is operatively coupled, via a network 802 to the bank's one or more commercial credit servers 806, one or more consumer credit servers 808, and one or more user computer systems 805. In this way, the credit exposure system 810 can receive and send information from and to the commercial exposure system 820, consumer exposure system 830, and user computer system 805. In some embodiments of the invention, the user 803 is an employee of the bank using the credit exposure system 810. However, in other embodiments of the invention the user 803 is an agent, contractor, or other person designated to act on behalf of the bank. The network 802 may be a global area network (GAN), such as the Internet, a wide area network (WAN), a local area network (LAN), or any other type of network or combination of networks. The network 802 may provide for wireline, wireless, or a combination of wireline and wireless communication between devices on the network.

As illustrated in FIG. 8, the credit exposure system 810 is located on the bank credit exposure server 804 and generally comprises a communication interface 812, a processor 814, and a memory 816. The processor 814 may include functionality to operate one or more software programs based on computer-readable instructions thereof, which may be stored in the memory 816.

The processor 814 is operatively coupled to the communication interface 812, and the memory 816. The processor 814 uses the communication interface 812 to communicate with the network 802 and other devices on the network 802, such as, but not limited to, the commercial credit servers 806, consumer credit servers 808, and the user computer systems 805. As such, the communication interface 812 generally comprises a modem, server, or other device for communicating with other devices on the network 802.

As further illustrated in FIG. 8, the credit exposure system 810 comprises computer-readable instructions 818 stored in the memory 816, which in one embodiment includes the computer-readable instructions 818 of a combined credit exposure application 817. In some embodiments, the memory 816 includes a datastore 819 for storing data related to the credit exposure system 810, including but not limited to data created and/or used by the combined credit exposure application 817.

The combined credit exposure application 817 generally provides a user 803 the ability to identify, receive, generate, view, and analyze a consolidated picture of exposure risk and/or revenue of a bank based on the bank's exposure to a customer, as well as the bank's exposure to related customers. The consolidated picture of exposure can include but is not limited to consumer exposure, consumer risk rating (FICO), commercial exposure, commercial risk rating, cross-sectional views based on company, sector, industry, geography, supplemental risk, and/or the like for a particular point in time or for a particular point in time as a function of the difference with a previous point in time. For example, the consolidated picture of exposure can include the exposure today based on the exposure yesterday, last week, last month, last quarter, last year, etc., thus illustrating an improvement or decay in the exposure over time. In some embodiments of the invention, the risk and/or revenue exposure is based on a customer that is a commercial customer and the related bank customers that use products at the bank. However, in other embodiments, it is to be understood that the risk and/or revenue exposure could be based on a consumer, a group of consumers, a group of commercial customers, or one or more combinations of consumers and commercial customers, as well as the related customers to each, which use products at the bank. The consolidated picture of the combined consumer and commercial exposure allows the user 803 at the bank to provide more effective risk management, consumer lending, commercial lending, investment banking, and/or the like by spreading risk and/or identifying areas in various commercial customers, sectors, industries, geographies, etc., that are under-supported or over-supported by the bank.

As further illustrated in FIG. 8, the commercial exposure system 820 is located on the commercial credit servers 806. The commercial exposure system 820 generally comprises a communication interface 822, a processor 824, and a memory 826. The processor 824 is operatively coupled to the communication interface 822 and the memory 826. The processor 824 uses the communication interface 822 to communicate with the network 802, and other devices on the network 802, such as, but not limited to, the bank credit exposure server 804, consumer credit server 808, and the user computer systems 805. As such, the communication interface 822 generally comprises a modem, server, or other device(s) for communicating with other devices on the network 802.

As illustrated in FIG. 8, the commercial exposure system 820 comprises computer-readable program instructions 828 stored in the memory 826, which in one embodiment includes the computer-readable instructions 828 of a commercial exposure application 840. In some embodiments, the memory 826 includes a datastore 829 for storing data related to the commercial exposure system 820, including but not limited to data created and/or used by the commercial exposure application 840.

The commercial exposure application 840 captures and stores information related to the commercial products provided by the bank to commercial customers and related commercial customers. The information includes, but is not limited to, the outstanding balance, payment schedule, term, account number, identification number, account holder, etc. for products, such as but not limited to, commercial business loans, commercial property loans, and other debt instruments for commercial customers and related commercial customers. In some embodiments of the invention, the commercial exposure application 840 can receive information from other servers and systems that capture and store information related to commercial products offered by the bank. In some embodiments of the invention, the commercial exposure application 840 is a part of the combined credit exposure application 817, and can receive information from other systems and servers related to products offered by the bank to commercial customers and related commercial customer directly from the other systems and servers located within and outside of the bank.

As further illustrated in FIG. 8, the consumer exposure system 830 is located on the consumer credit servers 808. The consumer exposure system 830 generally comprises a communication interface 832, a processor 834, and a memory 836. The processor 834 is operatively coupled to the communication interface 832 and the memory 836. The processor 834 uses the communication interface 832 to communicate with the network 802, and other devices on the network 802, such as, but not limited to, the bank credit exposure server 804, commercial credit server 806, and the user computer systems 805. As such, the communication interface 832 generally comprises a modem, server, or other device(s) for communicating with other devices on the network 802.

As illustrated in FIG. 8, the consumer exposure system 830 comprises computer-readable program instructions 838 stored in the memory 836, which in one embodiment includes the computer-readable instructions 838 of a consumer exposure application 860. In some embodiments, the memory 836 includes a datastore 839 for storing data related to the consumer exposure system 830, including but not limited to data created and/or used by the commercial exposure application 860.

The consumer exposure application 860 captures and stores the information related to the consumer products provided by the bank to consumers and related consumers. The information includes, but is not limited to, the outstanding balance, payment schedule, term, account number, identification number, account holder, etc. for products, such as but not limited to personal loans, mortgages, lines of credit, school loans, and other debt instruments for consumers and related consumers. In some embodiments of the invention, the consumer exposure application 860 can receive information from other servers and systems that capture and store information related to consumer products offered by the bank. In some embodiments of the invention the consumer exposure application 860 is a part of the combined credit exposure application 817 and can receive information from other systems and servers related to products offered by the bank to consumers and related consumers directly from various systems and servers located within and outside of the bank.

The user computer systems 805 have devices that are the same or similar to the devices described for the credit exposure system 810, commercial exposure system 820, and consumer exposure system 830 (i.e. communication interface, processor, memory with computer-readable instructions, datastore, etc.). Thus, the user computer systems 805 will communicate with the credit exposure system 810, the commercial exposure system 820, and consumer exposure system 830 in the same or similar way as previously described with respect to each. The user computer systems 805 may have a display, camera, keypad, mouse, keyboard, microphone, and/or speakers for communicating with one or more users 803. In this way, the user 803 can utilize the credit exposure application 817 to view and use the combined credit exposure interfaces, which may include those interfaces such as those illustrated in FIGS. 6 and 7.

It should be appreciated that, although FIG. 8 illustrates a separate credit exposure system 810, commercial exposure system 820, consumer exposure system 830, and user computer system 805, in some embodiments of the invention the separation between one or more of these systems is merely conceptual and, in reality, one or more of the hardware and/or software components described with regard to each system may be combined and/or shared by two or more of these systems. In other embodiments, however, the separation is real and not conceptual with regard to one or more of these systems.

FIG. 9 illustrates a combined credit exposure process 900 in accordance with one embodiment of the present invention. First the combined credit exposure application 817, at the direction of the user 803, or in other embodiments automatically, communicates with the commercial exposure system 820, in order to identify exposure information related to the credit exposure of one or more customers, such as a commercial customer, and receives the information from the commercial exposure application 840, as illustrated by block 902 in FIG. 9. In some embodiments of the invention, the user 803 is gathering information related to a specific company or groups of companies in order to identify the loan exposure to a specific company or groups of companies. For example, in one embodiment, the bank can gather information related to a specific company that uses the bank for products, such as Company A as illustrated in FIGS. 6A-6C, where Company A is, for example, part of the industrials sector in the aerospace and defense industry.

In some embodiments of the invention, as illustrated in block 904 the combined credit exposure application 817 identifies any consumer transactions the customer has made with consumers. For example, Company A's accounts are debited whenever they make a payment, such as a payroll direct deposit into the account of an employee of Company A. The credit exposure application 817 can receive from the commercial exposure system 820 (or other commercial banking systems and servers at the bank) all the payments Company A made to consumers. For example, in the case of the direct deposit of payroll, the bank can identify each employee that works for Company A by identifying all the payroll payments Company A made to consumers. The combined credit exposure application 817 captures identification information about the consumers. In some embodiments of the invention, due to right to privacy laws the bank does not identify the consumers by name, however, the bank can capture non-descriptive identification information of the consumers. The non-descriptive information can include, but is not limited to, identification numbers, addresses, payment amounts, account numbers, and/or the like. In other embodiments of the invention, it may be necessary and/or legal to identify the consumers though the use of a descriptive identification, such as the consumers' names, social security numbers, tax information, etc.

As illustrated by block 906, in some embodiments of the invention, the combined credit exposure application 817 communicates with the consumer exposure system 830 and uses the identification information (non-descriptive or descriptive) identified in block 904 to determine how many consumers have a relationship with the bank, and thus can be classified as related bank customers. For example, in the case of Company A, the credit exposure application 817 will match up any consumers that received a payment from Company A that were identified as employees, and cross-reference those consumers with accounts at the bank to see if the consumers use any products at the bank. In some embodiments, the payments made by Company A to consumers are deposited into accounts the consumers have with the bank. However, in other embodiments the payments made by Company A are deposited into accounts at other financial institutions, but the combined credit exposure application 817 can identify if the consumers that received payments from Company A have other accounts at the bank through the identification information captured in block 904.

Once the consumers are identified as related consumers the combined credit exposure application 817 can identify related consumer information such as consumer relationship information and consumer account information from the consumer exposure system 830 (or other systems and servers that store consumer information and are accessed over the network 802), as illustrated by block 908. The relationship information captured by the combined credit exposure application 817 can include, but is not limited to, the number of related consumers who utilize products offered by the bank, related consumer geographic location information (country, region, state, county, city, zip code, street address, etc.), credit score of related consumers, etc. The consumer account information can include, but is not limited to the amount of deposits, credit card balances, installment loans, lines of credit, mortgages, outstanding credit, unused lines of credit, and total consumer exposure (i.e. sum of the balances and loans) that the related consumers have with the bank. In some embodiments of the invention, the credit exposure application 817 communicates with other systems and servers at the bank, or outside of the bank, through the network 802 in order to capture information, such as, but not limited to the related consumer's credit score from a credit rating agency, etc.

In some embodiments of the invention the combined credit exposure application 817 can also determine the exposed risk and revenue for any related commercial customers. As illustrated by block 910, the combined credit exposure application 817 can identify the suppliers, (outbound transactions), distributors (inbound transactions), partners (inbound and outbound transactions) of the customer through payment transactions captured by the commercial exposure system 820 (or other system or server at the bank), such as wire transfers through automated clearing houses, deposited checks, or other transaction processes. For example, the combined credit exposure application 817 can identify all the suppliers, distributors, and partners of Company A by identifying the transactions Company A has made with other companies. As previously described with respect to the consumers, the credit exposure application 817 captures the commercial identification information (non-descriptive or descriptive), such as, but not limited to, address, payment information, account numbers, commercial customer identification numbers, commercial customer name, tax identification number, etc., of all of the commercial customers that have been involved in transactions with the customer.

As illustrated by block 912, in some embodiments of the invention, the combined credit exposure application 817 communicates with the commercial exposure system 820 and uses the commercial identification information (non-descriptive or descriptive) identified in block 910 to determine how many companies that were involved in transactions with the customer have a relationship with the bank, and thus can be classified as related commercial customers. For example, in the case of Company A, the credit exposure application 817 will match up any companies that were involved in transactions with Company A, and cross-reference those companies with accounts at the bank to see if the companies use any products at the bank, through the use of the commercial identification information. In some embodiments, the payments made between Company A and other companies are deposited into accounts the companies have with the bank. However, in other embodiments the payments made between Company A and other companies are deposited into accounts at other financial institutions, but the combined credit exposure application 817 can identify if the companies involved in transactions with Company A have other accounts at the bank through the commercial identification information captured in block 910.

Once the companies are identified as related commercial customers the combined credit exposure application 817 can identify related commercial customer information such as related commercial customer relationship information and related commercial customer account information from the commercial exposure system 830 (or other systems and servers that store commercial customer information and are accessed over the network 802), as illustrated by block 914. The relationship information captured by the combined credit exposure application 817 can include, but is not limited to, the number of related commercial customers who utilize products offered by the bank, related commercial customer geographic location information (country, region, state, county, city, zip code, street address, etc.), industry and sector information of the related commercial customers, credit ratings, bond ratings, etc. The related commercial customer account information can include, but is not limited to the amount of deposits, installment loans, lines of credit, commercial real estate loans, outstanding credit, unused lines of credit, and total related commercial customer exposure (i.e. sum of the balances and loans) that the related commercial customers have with the bank. In some embodiments of the invention, the credit exposure application 817 communicates with other systems and servers at the bank, or outside of the bank, through the network 802 in order to capture information, such as, but not limited to, industry or sector information, information about the company, size, number of employees, etc.

As illustrated by block 916 in FIG. 9, the combined credit exposure application 817 then calculates the combined credit exposure report for the customer. The combined credit exposure application 817 aggregates the customer information, with the related consumer information and the related commercial customer information to generate a report based on a request by the user 803, or set up automatically, in the combined credit exposure application 817. For example, the total amount of deposits, credits, loans, etc. is added up for the customer, and all of the related consumers and related commercial customers. In addition, in some embodiments the combined credit exposure application 817 determines some ratios of interest, such as, but not limited to, deposit-loan ratios, consumer-commercial exposure ratios, etc.

In some embodiments of the invention the combined credit exposure report generated is a static snapshot of the exposure at a particular point in time. For example the information captured by the combined credit exposure application 817, such as the customer information, related consumer information and related commercial customer information, may be time-stamped for a particular point in time when it was collected. In some embodiments of the invention, the information captured by the combined credit exposure application 817 for a particular point in time can be compared to the same or similar information captured at another point in time, such as the previous day, week, month, quarter, year, etc. Thus, the combined credit exposure application 817 can determine the exposure of a selected entity and related entities over two or more points in time, or an interval of time, to indicate if the exposure is improving or decaying with respect to time. Therefore, the report generated can include the combined credit exposure at a particular point in time, over two or more points in time, or both. For example, the report can include the change from one date to another in the consumer credit exposure, commercial credit exposure, total combined credit exposure, deposit-loan ratios, consumer-commercial exposure ratios, etc. over a period of time, to name a few metrics.

As illustrated by block 918 in FIG. 9 the information is presented to the user 803 in a meaningful interface. In some embodiments of the invention, the information included in the report is non-descriptive, in that it does not identify specific related consumers or related commercial customers, but generally provides information about groups of consumers, groups of commercial customers, industries, sectors, etc. However, in other embodiment the reports may contain specific descriptive information about related consumers and related commercial customers, so that users 803 can identify the risk and revenue exposure to specific consumers or commercial customers. For example, in some embodiments the reports generated are specific to individual companies, industries, sectors, or geography. However, in other embodiments the reports can create a snapshot of the banks exposure to a specific industry, sector, geographic location, etc. FIGS. 6A-6C and 7A-7C illustrate embodiments of the combined credit exposure interfaces 600, 700, which display the reports generated by the combined credit exposure application 817 for different types of consumer and commercial customer information. These interfaces display one embodiment of the reports that can be generated, it is to be understood that other types of reports can be generated by the combined credit exposure application 817 that display other metrics with respect to customers, related consumers, related commercial customers, etc.

It will be appreciated that, in the banking context, embodiments of the combined credit exposure application 817 may be used to help in both a risk management environment, as well as in an offensive aspect of indentifying areas that need additional exposure in both commercial banking and consumer banking The credit exposure application 817 can be used to create a bank risk control framework which cuts across the consumer and commercial areas of banking to identify areas, based on sector, industry, company, and geography that could be more risky for additional development because of an already overexposed credit risk. The credit exposure application 817 could be used in this sense to prevent the bank from directing additional funds to areas that could prove to be more risky because of too much credit exposure. The credit exposure application 817 is used to identify and redefine the acceptable levels of bank risk in specific sectors, industries, companies, geographies, etc. It may also be used to optimize the bank's portfolio by identifying and reducing tail risk. The credit exposure application 817 can be used to reduce credit exposure to consumers employed by a customer, and suppliers, distributors, partners, etc. related to the customer that have credit risk, by helping to identify and utilize risk transfer vehicles such as securitization and hedging. Furthermore, if a company suffers a risk rating drop or covenant breach, and the bank is uncertain as to whether to take a risk action on a customer, the bank's loan exposure to consumers that work for the commercial customer can factor into the decision for making additional credit available to the customer.

The combined credit exposure application 817 also provides offensive metrics for identifying opportunities for additional revenue streams. For example, the combined credit exposure application helps to identify group banking opportunities at companies with good risk ratings, but low consumer exposure. The combined credit exposure application 817 also helps identify other growth and diversification opportunities by identifying consumers, commercial customers, industries, and sectors that are underexposed. Other functions include helping to identify and manage exposure allocation between sectors, industries, commercial customers, and geographic locations. The combined credit exposure application 817 also helps to identify suppliers and distributors of companies who do not use products from the bank, in order to create an outreach program to initiate and deepen relationships.

The techniques for risk management and business opportunity identification, described above, were not available or had little use before embodiments of the present invention were developed. Embodiments of the present invention allow a bank to create a bridge between commercial exposure and consumer exposure to identify the data related to the total exposure of the bank for a customer in one location for manipulation, investigation, and analysis. Embodiments of the present invention also allow for more effective risk management through portfolio management, hedging, securitization, better compliance with regulators, etc. Embodiments of the invention also improve consumer lending by providing an increase in lending through recognized opportunities where bank exposure as a whole is relatively less than desirable, and also helps users exercise caution in lending to sectors, industries, or companies where the bank has a higher concentration of exposure. The combined credit consumer application 817 allows for increased commercial lending by managing exposure and pricing to sectors, industries, or companies considering overall bank exposure to each area. The combined credit consumer application 817 also helps users recognize opportunities to increase relationships with companies that do not use products and services from the bank. The combined credit consumer application 817 allows users to increase investment banking opportunities through new opportunities or mergers and acquisitions or other financial advisory activities by recognizing under and over exposed areas, companies, employees, suppliers, distributors, and partners.

In some embodiments of the invention the reports developed in the combined credit consumer application 817 should be combined with other financial information and reports to make the proper determinations for increasing or reducing exposure in particular sectors and industries for consumers and commercial customers.

As will be appreciated by one of ordinary skill in the art in view of this disclosure, the present invention may be embodied as an apparatus (including, for example, a system, machine, device, computer program product, and/or the like), as a method (including, for example, a business process, computer-implemented process, and/or the like), or as any combination of the foregoing. Embodiments of the present invention are described above with reference to flowchart illustrations and/or block diagrams of such methods and apparatuses. It will be understood that blocks of the flowchart illustrations and/or block diagrams, and/or combinations of blocks in the flowchart illustrations and/or block diagrams, can be implemented by computer-executable program instructions (i.e., computer-executable program code). These computer-executable program instructions may be provided to a processor of a general purpose computer, special purpose computer, or other programmable data processing apparatus to produce a particular machine, such that the instructions, which execute via the processor of the computer or other programmable data processing apparatus, create a mechanism for implementing the functions/acts specified in the flowchart and/or block diagram block or blocks. As used herein, a processor may be “configured to” perform a certain function in a variety of ways, including, for example, by having one or more general-purpose circuits perform the function by executing one or more computer-executable program instructions embodied in a computer-readable medium, and/or by having one or more application-specific circuits perform the function.

These computer-executable program instructions may be stored or embodied in a computer-readable medium to form a computer program product that can direct a computer or other programmable data processing apparatus to function in a particular manner, such that the instructions stored in the computer readable memory produce an article of manufacture including instructions which implement the function/act specified in the flowchart and/or block diagram block(s).

Any combination of one or more computer-readable media/medium may be utilized. In the context of this document, a computer-readable storage medium may be any medium that can contain or store data, such as a program for use by or in connection with an instruction execution system, apparatus, or device. The computer-readable medium may be a transitory computer-readable medium or a non-transitory computer-readable medium.

A transitory computer-readable medium may be, for example, but not limited to, a propagation signal capable of carrying or otherwise communicating data, such as computer-executable program instructions. For example, a transitory computer-readable medium may include a propagated data signal with computer-executable program instructions embodied therein, for example, in base band or as part of a carrier wave. Such a propagated signal may take any of a variety of forms, including, but not limited to, electro-magnetic, optical, or any suitable combination thereof. A transitory computer-readable medium may be any computer-readable medium that can contain, store, communicate, propagate, or transport program code for use by or in connection with an instruction execution system, apparatus, or device. Program code embodied in a transitory computer-readable medium may be transmitted using any appropriate medium, including but not limited to wireless, wireline, optical fiber cable, radio frequency (RF), etc.

A non-transitory computer-readable medium may be, for example, but not limited to, a tangible electronic, magnetic, optical, electromagnetic, infrared, or semiconductor storage system, apparatus, device, or any suitable combination of the foregoing. More specific examples (a non-exhaustive list) of the non-transitory computer-readable medium would include, but is not limited to, the following: an electrical device having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing.

It will also be understood that one or more computer-executable program instructions for carrying out operations of the present invention may include object-oriented, scripted, and/or unscripted programming languages, such as, for example, Java, Perl, Smalltalk, C++, SAS, SQL, Python, Objective C, and/or the like. In some embodiments, the one or more computer-executable program instructions for carrying out operations of embodiments of the present invention are written in conventional procedural programming languages, such as the “C” programming languages and/or similar programming languages. The computer program instructions may alternatively or additionally be written in one or more multi-paradigm programming languages, such as, for example, F#.

The computer-executable program instructions may also be loaded onto a computer or other programmable data processing apparatus to cause a series of operation area steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Embodiments of the present invention may take the form of an entirely hardware embodiment, an entirely software embodiment (including firmware, resident software, micro-code, etc.), or an embodiment combining software and hardware aspects that may generally be referred to herein as a “module,” “application,” or “system.”

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, combinations, and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus comprising:
a memory comprising account information stored therein about a plurality of accounts, the account information comprising transaction information and exposure information for each of the plurality of accounts; and
a processor communicably coupled to the memory, the processor configured to:
identify a selected entity,
use the transaction information to identify one or more related entities that are related to the selected entity,
use the account information to identify exposure information for the one or more related entities, and
determine a comprehensive view of the exposure to the selected entity based at least in part on the exposure information of the one or more related entities.

2. The apparatus of claim 1, wherein the processor is configured to:
use the account information to identify information about direct exposure to the selected entity in isolation; and
determine the comprehensive view of the exposure to the selected entity based at least in part on a combination of the exposure information of the one or more related entities and the information about direct exposure to the selected entity.

3. The apparatus of claim 2, wherein the processor is configured to determine the comprehensive view of the exposure to the selected entity by adding together the exposure information of the one or more related entities and the information about direct exposure to the selected entity.

4. The apparatus of claim 2, wherein the processor is configured to:
apply weighting factors to the exposure information of the one or more related entities; and
determine the comprehensive view of the exposure to the selected entity based at least in part on the weighting factors, the exposure information of the one or more related entities, and the information about direct exposure to the selected entity.

5. The apparatus of claim 4, wherein the processor is configured to:
use the transaction information to identify a type of relationship between the one or more related entities and the selected entity; and
apply the weighting factors to the exposure information of the one or more related entities based at least in part on the type of relationship.

6. The apparatus of claim 1, further comprising:
a communication interface communicably coupled to the processor and a display device, wherein the processor is further configured to use the communication interface to present on the display device the comprehensive view of the exposure to the selected entity.

7. The apparatus of claim 1, wherein the processor is further configured to:
determine comprehensive exposure information for each of a plurality of selected entities; and
aggregate the comprehensive views for a subset of the plurality of selected entities based on a common characteristic shared by the subset of the plurality of selected entities.

8. The apparatus of claim 7, further comprising:
a user interface configured to receive a user-selected characteristic from a user,
wherein the processor is configured to, in response to receiving the user-selected characteristic from the user, present the user with information about an aggregate of the comprehensive views for a subset of the plurality of selected entities, where the subset of the plurality of selected entities share the user-selected characteristic.

9. The apparatus of claim 7, wherein the common characteristic comprises a sector of the economy, an industry, or a geographic indicator.

10. The apparatus of claim 1, wherein the account information comprises information about accounts that customers have with an institution, wherein the transaction information comprises information about transactions processed at least in part by the institution for the customers, wherein the exposure information for the one or more related entities comprises the institution's exposure to the one or more related entities, and wherein the comprehensive view of the exposure to the selected entity comprises an estimate of the institution's exposure to the selected entity based at least in part on the one or more related entities.

11. The apparatus of claim 10, wherein the institution comprises a bank, wherein the accounts comprise bank accounts, and wherein the transactions comprise financial transactions.

12. The apparatus of claim 1, wherein the selected entity comprises a company, and wherein the one or more related entities comprise employees of the company.

13. The apparatus of claim 1, wherein the selected entity comprises a company, and wherein the one or more related entities comprise suppliers, distributors, contractors, or affiliates of the company.

14. The apparatus of claim 1, wherein the selected entity comprises an individual, and wherein the one or more related entities comprise an employer of the individual.

15. The apparatus of claim 1, wherein the transaction information comprises information about direct deposit, Automated Clearing House (ACH), check, payment, or payroll transactions, and wherein the processor is configured to identify the one or more related entities as being related to the selected entity based on the selected party engaging in a pre-defined frequency of direct deposit, Automated Clearing House (ACH), check, payment, or payroll transactions with the one or more related entities.

16. The apparatus of claim 1, wherein the processor is configured to identify the one or more related entities as being related to the selected entity based on the selected party engaging in a pre-defined frequency of transactions with the one or more related entities.

17. The apparatus of claim 1, wherein the exposure information for the one or more related entities comprises an institution's credit exposure to the one or more related entities, and wherein the comprehensive view of the exposure to the selected entity comprises an estimate of the institution's credit exposure to the selected entity based at least in part on the one or more related entities.

18. The apparatus of claim 17, wherein the credit exposure comprises loan or line of credit balances.

19. The apparatus of claim 1, wherein the exposure information for the one or more related entities comprises an institution's revenue exposure to the one or more related entities, and wherein the comprehensive view of the exposure to the selected entity comprises an estimate of the institution's revenue exposure to the selected entity based at least in part on the one or more related entities.

20. The apparatus of claim 1, wherein the memory comprises computer-executable program code stored therein, and wherein the processor is configured to perform the functions recited in claim 1 by executing the computer-executable program code.

21. A method comprising:
accessing a memory comprising account information stored therein about a plurality of accounts, the account information comprising transaction information and exposure information for each of the plurality of accounts;
identifying a selected entity;
using a computer to automatically identify, from the transaction information, one or more related entities that are related to the selected entity;
using a computer to automatically gather, from the account information, exposure information for the one or more related entities; and
using a computer to determine a comprehensive view of the exposure to the selected entity based at least in part on the exposure information of the one or more related entities.

22. The method of claim 21, further comprising:
using the account information to identify information about direct exposure to the selected entity in isolation; and
using a computer to determine the comprehensive view of the exposure to the selected entity based at least in part on a combination of the exposure information of the one or more related entities and the information about direct exposure to the selected entity.

23. The method of claim 21, further comprising:
using the transaction information to identify a type of relationship between the one or more related entities and the selected entity;
applying weighting factors to the exposure information of the one or more related entities based at least in part on the type of relationship; and
determining the comprehensive view of the exposure to the selected entity based at least in part on the weighting factors, the exposure information of the one or more related entities, and the information about direct exposure to the selected entity.

24. The method of claim 21, further comprising:
determining comprehensive exposure information for each of a plurality of selected entities; and
aggregating the comprehensive views for a subset of the plurality of selected entities based on a common characteristic shared by the subset of the plurality of selected entities.

25. The method of claim 21, wherein the account information comprises information about accounts that customers have with an institution, wherein the transaction information comprises information about transactions processed at least in part by the institution for the customers, wherein the exposure information for the one or more related entities comprises the institution's exposure to the one or more related entities, and wherein the comprehensive view of the exposure to the selected entity comprises an estimate of the institution's exposure to the selected entity based at least in part on the one or more related entities.

26. The method of claim 25, wherein the institution comprises a bank, wherein the accounts comprise bank accounts, and wherein the transactions comprise financial transactions.

27. The method of claim 21, wherein the selected entity comprises a company, and wherein the one or more related entities comprise employees of the company.

28. The method of claim 21, wherein the transaction information comprises information about direct deposit, Automated Clearing House (ACH), check, payment, or payroll transactions, and wherein the method further comprises:
identifying the one or more related entities as being related to the selected entity based on the selected party engaging in a pre-defined frequency of direct deposit, Automated Clearing House (ACH), check, payment, or payroll transactions with the one or more related entities.

29. The method of claim 21, further comprising:
identifying the one or more related entities as being related to the selected entity based on the selected party engaging in a pre-defined frequency of transactions with the one or more related entities.

30. The method of claim 1, wherein the exposure information for the one or more related entities comprises an institution's credit exposure to the one or more related entities, and wherein the comprehensive view of the exposure to the selected entity comprises an estimate of the institution's credit exposure to the selected entity based at least in part on the one or more related entities.

31. The method of claim 30, wherein the credit exposure comprises loan or line of credit balances.

32. The method of claim 1, wherein the exposure information for the one or more related entities comprises an institution's revenue exposure to the one or more related entities, and wherein the comprehensive view of the exposure to the selected entity comprises an estimate of the institution's revenue exposure to the selected entity based at least in part on the one or more related entities.

33. A computer program product comprising a non-transitory computer readable medium having computer-executable program code stored therein, wherein the computer-executable program code comprises:
a first code portion configured to access a memory comprising account information stored therein about a plurality of accounts, the account information comprising transaction information and exposure information for each of the plurality of accounts;
a second code portion configured to identify a selected entity;
a third code portion configured to identify, from the transaction information, one or more related entities that are related to the selected entity;
a fourth code portion configured to gather, from the account information, exposure information for the one or more related entities; and
a fifth code portion configured to determine a comprehensive view of the exposure to the selected entity based at least in part on the exposure information of the one or more related entities.

34. The computer program product of claim 33, further comprising:
a sixth code portion configured to use the account information to identify information about direct exposure to the selected entity in isolation,
wherein the fifth code portion is configured to determine the comprehensive view of the exposure to the selected entity based at least in part on a combination of the exposure information of the one or more related entities and the information about direct exposure to the selected entity.

35. The computer program product of claim 33, further comprising:
a sixth code portion configured to use the transaction information to identify a type of relationship between the one or more related entities and the selected entity; and
a seventh code portion configured to apply weighting factors to the exposure information of the one or more related entities based at least in part on the type of relationship,
wherein the fifth code portion is configured to determine the comprehensive view of the exposure to the selected entity based at least in part on the weighting factors, the exposure information of the one or more related entities, and the information about direct exposure to the selected entity.

36. The computer program product of claim 33, further comprising:
a sixth code portion configured to identify the one or more related entities as being related to the selected entity based on the selected party engaging in a pre-defined frequency of transactions with the one or more related entities.

37. The computer program product of claim 33, wherein the exposure information for the one or more related entities comprises an institution's credit exposure to the one or more related entities, and wherein the comprehensive view of the exposure to the selected entity comprises an estimate of the institution's credit exposure to the selected entity based at least in part on the one or more related entities.
